(19) United States
(12) Patent Application Publication
(10) Pub. No.: US 2016/0154907 A1
(43) Pub. Date: Jun. 2, 2016

(54) INTEGRATED NETWORK ASSET MODELING

(71) Applicant: Schlumberger Technology Corporation, Sugar Land, TX (US)

(72) Inventors: Vijaya Halabe, Katy, TX (US); Robert Sauve, Katy, TX (US)

(21) Appl. No.: 14/556,561

(22) Filed: Dec. 1, 2014

(51) Int. Cl. G06F 17/50

(52) U.S. Cl. CPC G06F 17/509

(57) ABSTRACT

A method, apparatus, and program product for building an integrated network asset model for an oil and gas production system. A surface production network model associated with the oil and gas production system is retrieved. At least one well object of the surface production network is determined. Fluid properties for the at least one well object are determined based at least in part on a reservoir model associated with the oil and gas production system, and the integrated network asset model for the oil and gas production system is built based at least in part on the surface production network model, the at least one well object, and the fluid properties for the at least one well object.

### BACKGROUND

Generally, oil and gas production systems comprise a surface production network of components/equipment (e.g., well heads, pumps, conduits, meters, etc.) that are associated with an oil and gas reservoir via one or more wells. Production networks are generally constrained by boundary conditions such as pressures, maximum flow rates, erosional velocities, fluid compositions, etc., as well as by additional physical constraints such as the sizes and/or types of conduits and other equipment in the network. In turn, pressures, fluid compositions, and/or other such variables may be based at least in part on an oil and gas reservoir associated with the production network.

Computer based systems and methods are increasingly being used to aid in modeling and managing oil and gas production systems. However, conventional systems and methods generally rely on input from oil and gas system professionals, and such conventional systems and methods generally provide limited analysis of individual components and/or limited reservoir characteristics which must then be interpreted by such oil and gas system professionals. Therefore, a need continues to exist in the art for improved computer based systems and methods for modeling, managing, and analyzing oil and gas production systems.

### SUMMARY

Embodiments disclosed herein provide systems, methods, and computer program products that build an integrated network asset model for an oil and gas production system and analyze the oil and gas production system. A surface production network model associated with the oil and gas production system may be retrieved. At least one well object associated with the network model may be determined. Fluid properties for the at least one well object may be determined based at least in part on a reservoir model associated with the oil and gas production system. An integrated network asset model for the oil and gas production system may be built based at least in part on the network model, the at least one well object, and the fluid properties for the at least one well object.

In some embodiments, an oil and gas production system may be analyzed. In these embodiments, an integrated network asset model for the oil and gas production system may be built based at least in part on a surface network model and a reservoir model associated with the oil and gas production system. A steady state of the integrated network asset model may be simulated to determine fluid properties for the integrated network asset model, and a visualization of the integrated network asset model that includes the fluid properties and a coordinate system based at least in part on the surface network model and the reservoir model may be generated.

In some embodiments an oil and gas production system may be analyzed. In these embodiments, an integrated network asset model that includes fluid parameters and simulation diagnostic information associated with the oil and gas production system may be retrieved. A branch profile for at least one branch of the integrated network asset model may be determined based at least in part on the fluid parameters and the simulation diagnostic information. Network components of the at least one branch of the integrated network asset model may be reduced based at least in part on the branch profile to generate a conditioned network asset model for the oil and gas production system.

These and other advantages and features are set forth in the claims annexed hereto and forming a further part hereof. However, for a better understanding of embodiments, and of the advantages and objectives attained through use, reference should be made to the Drawings, and to the accompanying descriptive matter, in which there is described example embodiments. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 provides a flowchart that illustrates a sequence of operations that may be performed by the data processing system of FIG. 1 to build an integrated network asset model.

FIGS. 6A-G provide diagrammatic illustrations of example graphical user interfaces that may be output on a display connected to the data processing system of FIG. 1.

FIG. 7 provides an example chart that illustrates black oil de-lumping applied to the hydrocarbon phase K components that may be implemented by the data processing system of FIG. 1.

FIG. 8 provides a flowchart that illustrates a sequence of operations that may be performed by the data processing system of FIG. 1 to determine a fluid transition for compositional N components reservoir fluid to compositional K components network fluid.

FIG. 9 provides a flowchart that illustrates a sequence of operations that may be performed by the data processing system of FIG. 1 consistent with some embodiments to generate a visualization for a simulation.

FIGS. 10A-D provide example graphical user interfaces that may be generated by the data processing system of FIG. 1.

FIG. 11 provides a flowchart that illustrates a sequence of operations that may be performed by the data processing system of FIG. 1 to condition a network asset model consistent with some embodiments.

FIG. 12 provides a graphical user interface that may be generated by the data processing system of FIG. 1.

FIG. 13 provides an example chart that illustrates a FEL based field development plan that may be implemented by the data processing system of FIG. 1.

FIG. 14 provides a flowchart that illustrates a sequence of operations that may be performed by the data processing system of FIG. 1 to perform integrated asset modeling.

FIG. 15 provides an example graphical user interface that may be generated by the data processing system of FIG. 1.

FIG. 16 provides a diagrammatic illustration of an example input, process, and output workflow that may be implemented by the data processing system of FIG. 1.

FIG. 17 provides a diagrammatic illustration of an example input, process, and output workflow that may be implemented by the data processing system of FIG. 1.

FIG. 18 provides an example chart that illustrates results from simulation runs that may be generated by the data processing system of FIG. 1.

FIGS. 19-23 provide example graphical user interfaces that may be generated by the data processing system of FIG. 1.

FIGS. 24A-B provide a flowchart that illustrates a sequence of operations for a workflow that may be implemented by the data processing system of FIG. 1.

### DETAILED DESCRIPTION

The herein-described embodiments provide methods, systems, and computer program products that build a network asset model for an oil and gas production system, where the network asset model is associated with a surface production network and an associated oil and gas reservoir. As such, consistent with embodiments, reservoir modeling and surface production modeling may be integrated into a network asset model, such that an asset (i.e., the oil and gas production system) may be modeled from subsurface composition of a reservoir to sales/collection at an output of a surface production network. Embodiments may facilitate an interface for a user (e.g., an oil and gas production system professional) to interact with a computer implemented workflow that facilitates creation/importation of an oil and gas reservoir model, creation/importation of one or more surface production network models (also referred to herein as a network model), creation/conditioning of an integrated network asset model based on the reservoir model and the surface production network model, simulation of scenarios for the network asset model, and/or visualization of modeling and/or simulation results.

Some embodiments provide a system, method, and computer program product for analyzing an oil and gas production system. The method comprises: building, with at least one processor, an integrated network asset model for the oil and gas production system based at least in part on a surface production network model for the oil and gas production system and a reservoir model associated with the oil and gas production system; simulating, with the at least one processor, the integrated network asset model to determine fluid properties for the network asset model; and generating, with the at least one processor, at least one visualization of the integrated network asset model including the fluid properties and a coordinate system based at least in part on the surface production network model and the reservoir model.

The method may further comprise determining a simulation platform for the simulation. In some embodiments, the simulation platform is a distributed processing platform, the method further comprising: determining at least one simulation task to be performed by at least one remote data processing system.

In some embodiments, the integrated network asset model comprises at least one well object that couples the surface production network model to the reservoir model, the method further comprising: determining at least one balancing constraint for the at least well object, wherein simulating the network asset model is based at least in part on the at least one balancing constraint.

In some embodiments, the integrated network asset model comprises at least one well object that couples the surface production network model to the reservoir model, the method further comprising: determining at least one balancing constraint for the at least well object, wherein simulating the network asset model is based at least in part on the at least one balancing constraint. Furthermore, the at least one balancing constraint may comprise gas rate, oil rate, water rate, liquid rate, volume rate, top hole pressure, bottom hole pressure, or any combination thereof. The method may further comprise: determining a balancing location for the at least one well object for the at least one well object, wherein simulation the network asset model is based at least in part on the balancing location.

In some embodiments, simulating the integrated network asset model is performed as a time step simulation, and generating the at least one visualization of the integrated network asset model comprises: generating at least one visualization of the integrated network asset model that includes fluid properties for at least two different time periods associated with two time step increments of the time step simulation.

The method may further comprise collecting results data during the simulation for the integrated network asset model, wherein the fluid properties are based at least in part on the results data.

In some embodiments, the method further comprises: collecting results data during the simulation for a plurality of well objects of the network asset model; and analyzing the results data to identify at least one unstable well object, wherein the at least one visualization of the integrated network asset model comprises indicators of the plurality of well objects and an indicator that identifies the at least one unstable well object.

As will be appreciated, the method may be implemented in a system comprising at least one processor; a memory; and program code configured to be executed by the at least one processor to cause the at least one processor to perform the operations of the methods described herein. Similarly, a computer readable medium may comprise program code configured to be executed by at least one processor to cause the at least one processor to perform the operations of the methods described herein. In at least one embodiment, the program code may be configured upon execution to cause the at least one processor to: build an integrated network asset model for the oil and gas production system based at least in part on a surface production network model for the oil and gas production system and a reservoir model associated with the oil and gas production system; simulate the integrated network asset model to determine fluid properties for the network asset model; and generate at least one visualization of the integrated network asset model including the fluid properties and a coordinate system based at least in part on the surface production network model and the reservoir model.

Other embodiments provide a system, method, and computer program product for analyzing an oil and gas production system. The method comprises: retrieving, with at least one processor, an integrated network asset model associated with the oil and gas production system including fluid parameters and simulation diagnostic information determined for the integrated network asset model, wherein the integrated network asset model is based at least in part on a surface production model and a reservoir model; determining a branch profile for at least one branch of the integrated network asset model based at least in part on the fluid parameters and the simulation diagnostic information; and reducing network components of the at least one branch of the integrated network asset model based at least in part on the branch profile to generate a conditioned integrated network asset model for the oil and gas production system.

The method further comprises: simulating balancing of the oil and gas production system using the conditioned integrated network asset model to determine diagnostic information for the oil and gas production system. In at least one embodiment, the diagnostic information corresponds to a failure to converge event, a failure to flow event, a pressure mismatch event, a flow mismatch event, or any combination thereof.

In some embodiments, the diagnostic information is collected during the simulation, and simulating the oil and gas production system using the conditioned integrated network asset model comprises: analyzing the diagnostic information as the diagnostic information is collected during simulation to detect an error.

Furthermore, simulating the oil and gas production system using the conditioned integrated network asset model further comprises: stopping the simulation in response to detecting the error.

In some embodiments, the method further comprises: determining a desired field management strategy for the oil and gas production system; and simulating operation of the oil and gas production system using the conditioned integrated network asset model based on the field management strategy to determine fluid parameters for the oil and gas production system for the desired field management strategy. Furthermore, in some embodiments, the fluid parameters for the oil and gas production system for the desired field management strategy includes an identification of at least one network object associated with a flow constraint issue for the oil and gas production system. In addition, in some embodiments, the fluid parameters for the oil and gas production system for the desired field management strategy includes an identification of at least one network object associated with a pressure issue for the oil and gas production system. Moreover, in some embodiments, the method further comprises: further conditioning the conditioned integrated network asset model based at least in part on the fluid parameters for the desired field management strategy.

As will be appreciated, the method may be implemented in a system comprising at least one processor; a memory; and program code configured to be executed by the at least one processor to cause the at least one processor to perform the operations of the methods described herein. Similarly, a computer readable medium may comprise program code configured to be executed by at least one processor to cause the at least one processor to perform the operations of the methods described herein. In at least one embodiment, the program code may be configured upon execution to: retrieve an integrated network asset model associated with the oil and gas production system including fluid parameters and simulation diagnostic information determined for the integrated network asset model, wherein the integrated network asset model is based at least in part on a surface production model and a reservoir model; determine a branch profile for at least one branch of the integrated network asset model based at least in part on the fluid parameters and the simulation diagnostic information; and reduce network components of the at least one branch of the integrated network asset model based at least in part on the branch profile to generate a conditioned integrated network asset model for the oil and gas production system.

Other variations and modifications will be apparent to one of ordinary skill in the art.

### Hardware and Software Environment

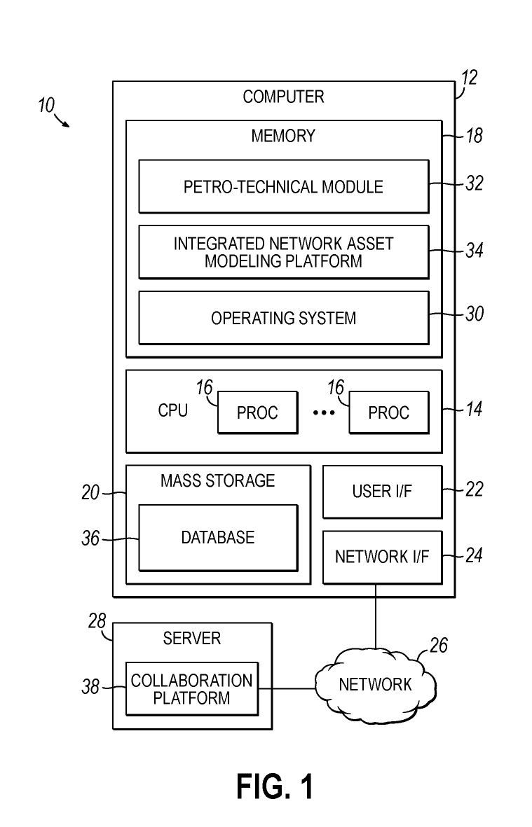

Turning now to the drawings, wherein like numbers denote like parts throughout the several views, FIG. 1 illustrates an example data processing system 10 in which the various technologies and techniques described herein may be implemented. System 10 is illustrated as including one or more computers 12, e.g., client computers, each including a central processing unit (CPU) 14 including at least one hardware-based processor or processing core 16. CPU 14 is coupled to a memory 18, which may represent the random access memory (RAM) devices comprising the main storage of a computer 12, as well as any supplemental levels of memory, e.g., cache memories, non-volatile or backup memories (e.g., programmable or flash memories), read-only memories, etc. In addition, memory 18 may be considered to include memory storage physically located elsewhere in a computer 12, e.g., any cache memory in a microprocessor or processing core, as well as any storage capacity used as a virtual memory, e.g., as stored on a mass storage device 20 or on another computer coupled to a computer 12.

Each computer 12 also generally receives a number of inputs and outputs for communicating information externally. For interface with a user or operator, a computer 12 generally includes a user interface 22 incorporating one or more user input/output devices, e.g., a keyboard, a pointing device, a display, a printer, etc. Otherwise, user input may be received, e.g., over a network interface 24 coupled to a network 26, from one or more external computers, e.g., one or more servers 28 or other computers 12. A computer 12 also may be in communication with one or more mass storage devices 20, which may be, for example, internal hard disk storage devices, external hard disk storage devices, storage area network devices, etc.

A computer 12 generally operates under the control of an operating system 30 and executes or otherwise relies upon various computer software applications, components, programs, objects, modules, data structures, etc. For example, a petro-technical module or component 32 executing within an oil and gas integrated network asset modeling platform 34 (also referred to herein as modeling platform) may be used to access, process, generate, modify or otherwise utilize petro-technical data, e.g., as stored locally in a database 36 and/or accessible remotely from a collaboration platform 38. Collaboration platform 38 may be implemented using multiple servers 28 in some implementations, and it will be appreciated that each server 28 may incorporate a CPU, memory, and other hardware components similar to a computer 12.

In one non-limiting embodiment, for example, oil and gas production system integrated network asset modeling platform 34 may implemented and/or in communication with one or more of the following: the PETREL Exploration & Production (E&P) software platform, PIPESIM Steady-State Multiphase Flow Simulator, ECLIPSE Industry Reference Reservoir Simulator, INTERSECT High-Resolution Reservoir Simulator, Field Management Controller while collaboration platform 38 may be implemented as the STUDIO E&P KNOWLEDGE ENVIRONMENT platform, and/or Avocet Platform, which are available from Schlumberger Ltd. and its affiliates. It will be appreciated, however, that the techniques discussed herein may be utilized in connection with other platforms and environments, so embodiments are not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more hardware-based processing units in a computer (e.g., microprocessors, processing cores, or other hardware-based circuit logic), cause that computer to perform the steps embodying desired functionality. Moreover, while embodiments have and hereinafter will be described in the context of fully functioning computers and computer systems, those skilled in the art will appreciate that the various embodiments are capable of being distributed as a program product in a variety of forms, and that the subject matter disclosed herein applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by computer 10. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment. However, it should be appreciated that any particular program nomenclature that follows is used merely for convenience, and thus embodiments should not be limited to use solely in any specific application identified and/or implied by such nomenclature. Furthermore, given the endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that embodiments are not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, and/or supplemented with other techniques known in the art, and therefore, embodiments are not limited to the particular sequences of operations described herein.

Those skilled in the art will recognize that the example environment illustrated in FIG. 1 is not intended to limit embodiments. Indeed, those skilled in the art will recognize that other alternative hardware and/or software environments may be used without departing from the scope of the disclosure.

### Oilfield Operations

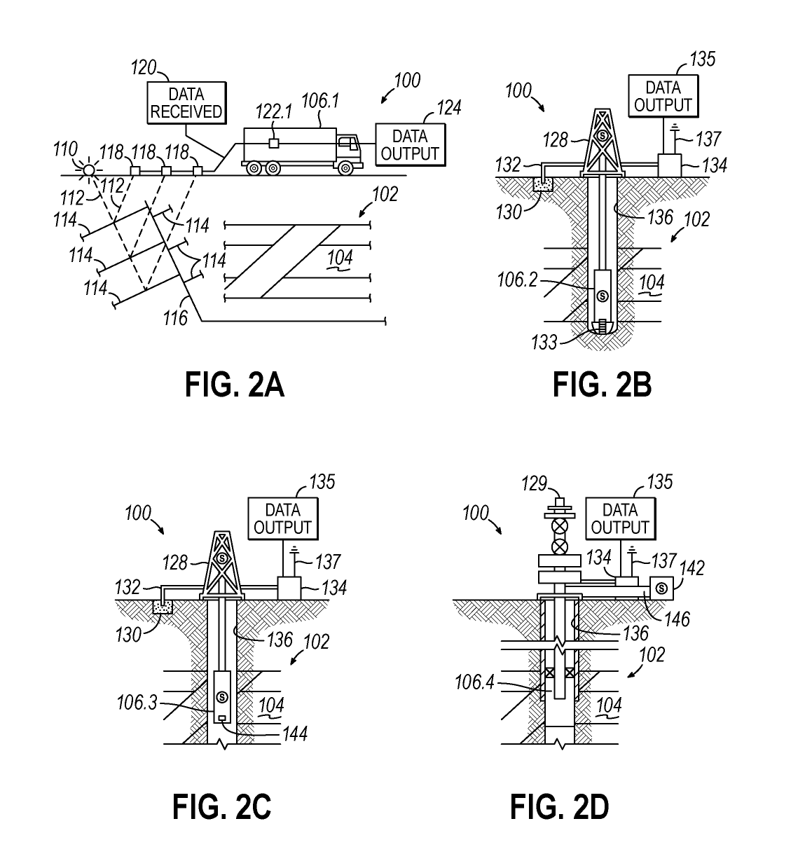

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud may be filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 2D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

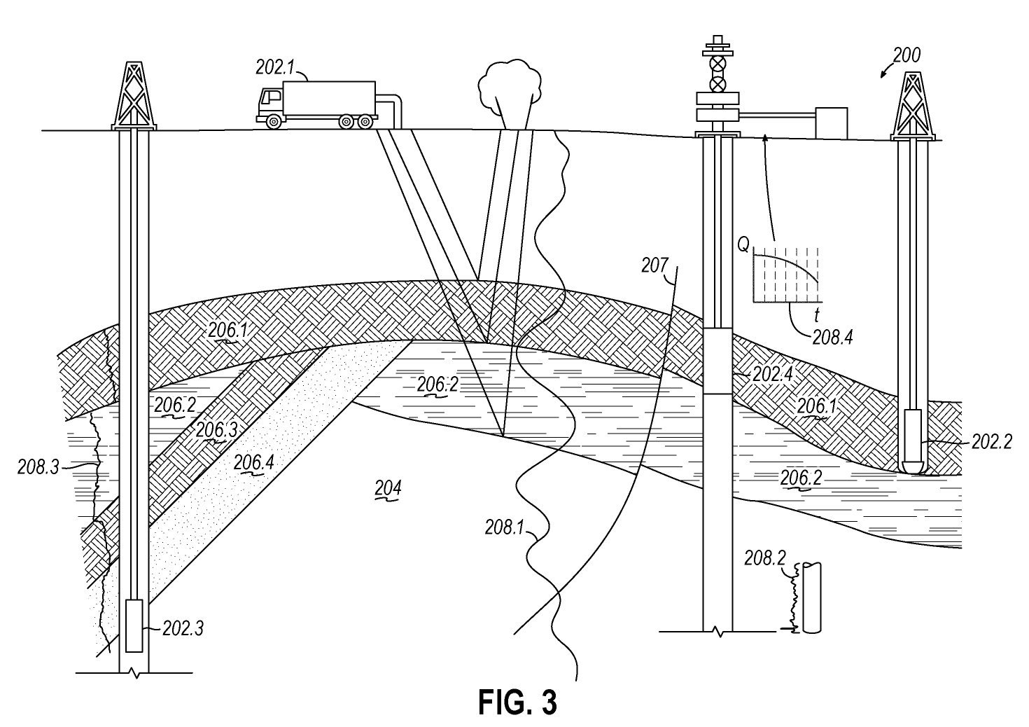

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 3, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

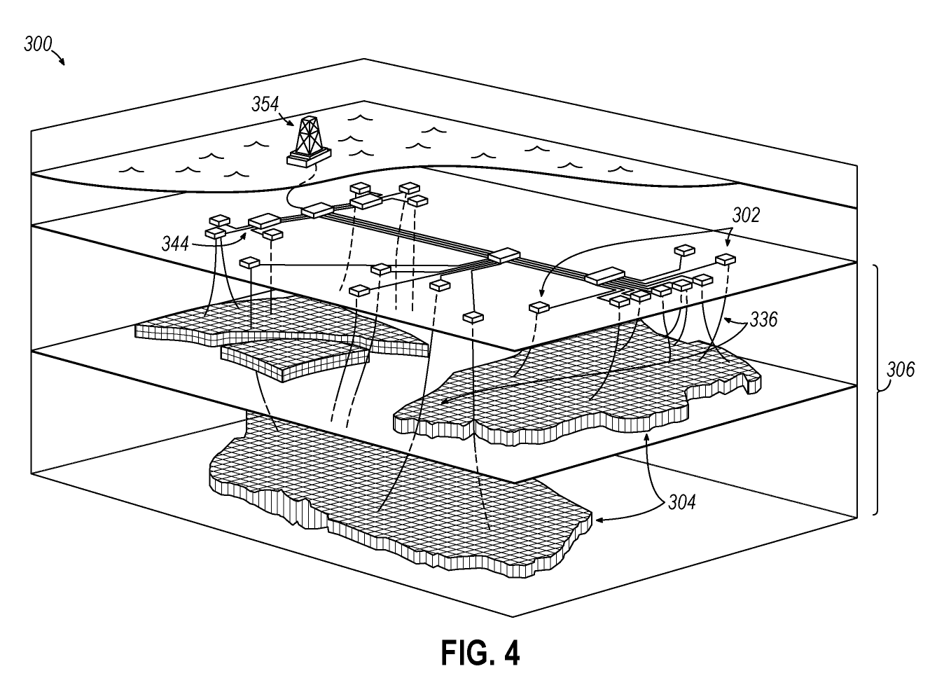

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Integrated Network Asset Modeling

Embodiments may be used to generate a modeling environment and workflow that integrates reservoir modeling and surface production network modeling to generate a network asset model for an oil and gas production system. Consistent with some embodiments, a surface production network model may be retrieved and/or created for an oil and gas production system by reconciling wells (also referred to as well objects) and fluids. Embodiments may generate one or more visualizations of the network model, such as two dimensional, three dimensional, and/or map based visualizations. The one or more visualizations of the network model may be output via a graphical user interface on a display associated with a computing system. In some embodiments, a steady state simulation may be performed with the network model such that fluid properties may be determined. In addition, changes in fluid inputs for the network model may trigger a steady state simulation to determine changes in fluid properties, where such changes may be incorporated into the one or more visualizations.

A reservoir model associated with the oil and gas production system may be retrieved and/or created. Generally, the reservoir model may comprise fluid properties for a modeled reservoir and/or simulation information associated with the modeled reservoir. In the generated workflow, an interface may be generated through which a user may define one or more field management strategies, including, for example, a history strategy, a depletion strategy, a water/gas flood strategy, a depletion strategy with actions on wells (e.g., shutting completions, black oil and compositional) and economic limits, compositional gas re-injection strategy, drilling queues and operating targets, thermal strategy with multi-segmented well (MSW), or any combination thereof. Generally, a history strategy may be a set of instructions to utilize historical observed production rates (e.g., water, oil and gas) to thereby tune the reservoir model in order to match reservoir properties, such as pressures, within the oil and gas production system. A depletion strategy may be a set of instructions to control reservoir pressures to thereby maximize recovery as the reservoir depletes. A water and/or gas flood strategy may be a set of instructions to control water and/or gas injection rates with the objective of maintaining reservoir pressure and maximizing recovery. A compositional gas re-injection strategy may be a set of instructions to optimize the miscibility of the gas in oil for improving recovery. Drilling queue strategy may be a set of instructions to define the sequence of drilling wells and may consist of logic to determine the number of drilled wells based on meeting a production target. Thermal strategy may be a set of instructions to control steam injection to maximize heavy oil production while minimizing operating costs of steam.

An integrated asset model may be built for the oil and gas production system by mapping the reservoir model to one or more well objects of the surface production network model and mapping fluid transition therebetween. In some embodiments, building the integrated asset model may comprise updating and/or replacing simulation information associated with the reservoir model and/or the surface production network model, such as vertical flow performance (VFP) tables. Fluid transitions between the reservoir and the surface production network may be determined, including black oil to black oil, black oil to compositional, compositional (N components) to compositional (K components), or any combination thereof. For analysis of the oil and gas production system using the integrated asset model, a user may select display, network balancing, and/or simulation options, and one or more simulation runs may be performed using the integrated asset model based on the input options. Simulation information collected from the one or more simulations using the integrated asset model may be analyze and validate the integrated asset model by comparing the simulation results to simulation information determined using the reservoir model and/or surface production network model.

The integrated asset model, reservoir model, and/or network model may be conditioned based at least in part on the simulation information determined from the one or more simulation runs performed using the integrated asset model. For example, one or more component objects of one or more branches of the surface production network may be simplified for analysis purposes based on simulation information and/or diagnostic information determined during one or more simulations. After conditioning, a user may define one or more fluid management strategies on an asset level, and one or more simulations may be performed using the conditioned models. In addition, alternative scenarios may be simulated and compared using the conditioned integrated asset model, including, for example, de-bottlenecking, field development planning, sensitivity, risk and uncertainty, guide rate/target production with network constraints, network re-branching, optimization, or any combination thereof.

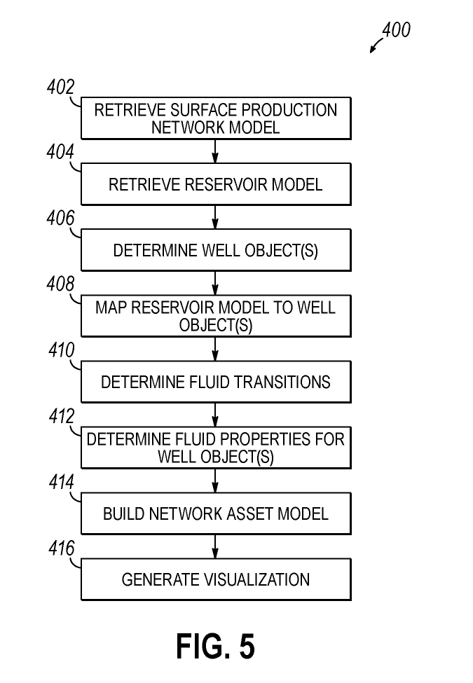

Turning now to FIG. 5, this figure provides a flowchart 400 that illustrates a sequence of operations that may be performed by the system 10 of FIG. 1 to build an integrated asset model for an oil and gas production system including an oil and gas reservoir model integrated with a surface production network model consistent with embodiments. Consistent with some embodiments, a software based platform may generate a graphical user interface through which a user (e.g., an oil and gas production system professional) may interact with the platform to facilitate generating a network asset model for an oil and gas production system. A surface production network model corresponding to the oil and gas production system may be retrieved (block 402). In general, a surface production network model may comprise one or more network components, such as well heads, pumps, conduits, separators, heaters, coolers, compressors, multiphase boosters, chokes, valves, and/or meters. Furthermore, the surface production network model may include one or more well objects to which network components may be connected. In general, a combination of connected network components may be referred to as a branch. Consistent with some embodiments, the graphical user interface may output visualizations of surface production networks from which a user may select a particular surface production network to retrieve.

A reservoir model associated with the oil and gas production system may be retrieved (block 404). In general, a reservoir model may include compositional and/or geological/geophysical information associated with a reservoir of the oil and gas production system. Such compositional information may include fluid composition and properties for the reservoir, while geological/geophysical information may include structural properties for subsurface formations associated with the reservoir, structural force characteristics associated with the reservoir, and/or other such characteristics. As should be appreciated, a user may select a stored reservoir model for retrieval and/or a user may build a reservoir in the modeling platform 34.

One or more well objects of the surface production network model may be determined (block 406), and the one or more well objects may be mapped to the reservoir model (block 408). Mapping the reservoir model to the one or more well objects of the surface production network model may be based at least in part on a coordinate system of the surface production network model. For example, geographical coordinates of the surface production network model may be used to determine a mapping of the reservoir model to the well objects.

In general, well objects may be defined in the surface production network model and/or the reservoir model, where such well objects generally represent a well that corresponds to a connection point between the reservoir and the surface production network of the oil and gas production system. Based on the one or more mapped well objects, fluid transitions between the reservoir model and the surface production network model are determined (block 410). Fluid transitions between the reservoir model and the surface production network model may correspond to black oil to black oil transitions, black oil to compositional transitions, compositional (N components) to compositional (K components), where K>N, and/or other such fluid transitions utilized in oil and gas production system modeling, analysis, and/or management. Based on the one or more mapped well objects, the reservoir model, and the fluid transitions, fluid properties for the one or more well objects may be determined (block 412).

Based on the determined fluid properties, the network model, one or more well objects, fluid transitions and/or the reservoir model, the system 10 may build a network asset model for the oil and gas production system (block 414). Generally, a network asset model comprises a single asset model that incorporates the surface production network model and the reservoir model, such that characteristics and properties of an entire oil and gas production system may be modeled and such that the one or more simulations may be performed for the oil and gas production system. Therefore, a network asset model facilitates asset modeling generally associated with subsurface modeling and above surface network system modeling. Furthermore, consistent with some embodiments, the oil and gas production system may be associated with more than one reservoir, such that the network asset model may integrate surface modeling of network components and subsurface modeling of more than one reservoir. The system 10 may generate a visualization based on the network asset model (block 416), where the visualization may include indicators for one or more fluid properties. Furthermore, the visualization may be output via the graphical user interface generated by system 10 for review by a user.

In general, the system 10 may generate a graphical user interface through which a user may interface with the system to select a surface production network model and/or one or more reservoir models for use in generating a network asset model associated with an oil and gas production system. The graphical user interface may be displayed via one or more display components of the system 10 (such as a monitor), and a user may provide user input via one or more user interface components (such as a keyboard and/or mouse). For example, a user may browse stored surface production network model data files and/or stored reservoir model data files, and/or a user may input identifying information via the graphical user interface to search for relevant surface production network model data files and/or reservoir model data files. In some embodiments, a user may view a representation and/or component information for a particular surface production network model associated with surface production network model data files prior to selecting the particular surface production network for retrieval. In these embodiments, a two-dimensional, and/or three dimensional visualization of a particular surface production network model may generate for display via the graphical user interface. Concurrent with generating a two-dimensional and/or three-dimensional visualization, the system 10 may convert a coordinate system associated with the particular surface production network model to a platform defined coordinate system and/or a reservoir model compatible coordinate system.

Furthermore, in some embodiments the visualization may be interactive such that a user may select network components and/or a branch of the surface production network, and properties of the selected network components and/or branch may be output for user review. Therefore, in these embodiments, responsive to user input selecting a network component and/or a branch, embodiments may determine one or more properties for the selected network component/branch and output the properties for review by the user via the graphical user interface. After selection of a particular surface production network model for retrieval, embodiments may reconcile an imported surface production network model with a reservoir model. In some embodiments, one or more network components of the surface production network model may be reconciled with the reservoir model, including, for example, well objects that may be mapped to the reservoir model. For fluids associated with the reservoir model, fluid transitions associated with the well objects may be determined based on fluid characteristics of the reservoir model and the well objects of the surface production network model.

Consistent with embodiments, fluid transitions and/or fluid properties may be determined by using flash separation to evaluate pressure, volume, and temperature at various temperatures and pressures. A phase envelope may be generated based on the fluid transitions and/or fluid properties. The system 10 may generate one or more charts corresponding to flashes, envelopes, and/or true boiling point (TBP) curves for display to the user via the graphical user interface such that the user may compare model descriptions based at least in part on pressure, volume, and/or temperature behavior. Fluid properties may be determined for various pressure, volume, temperature ranges such that data exchange between the surface production network model and the reservoir model may be based at least in part on the fluid properties.

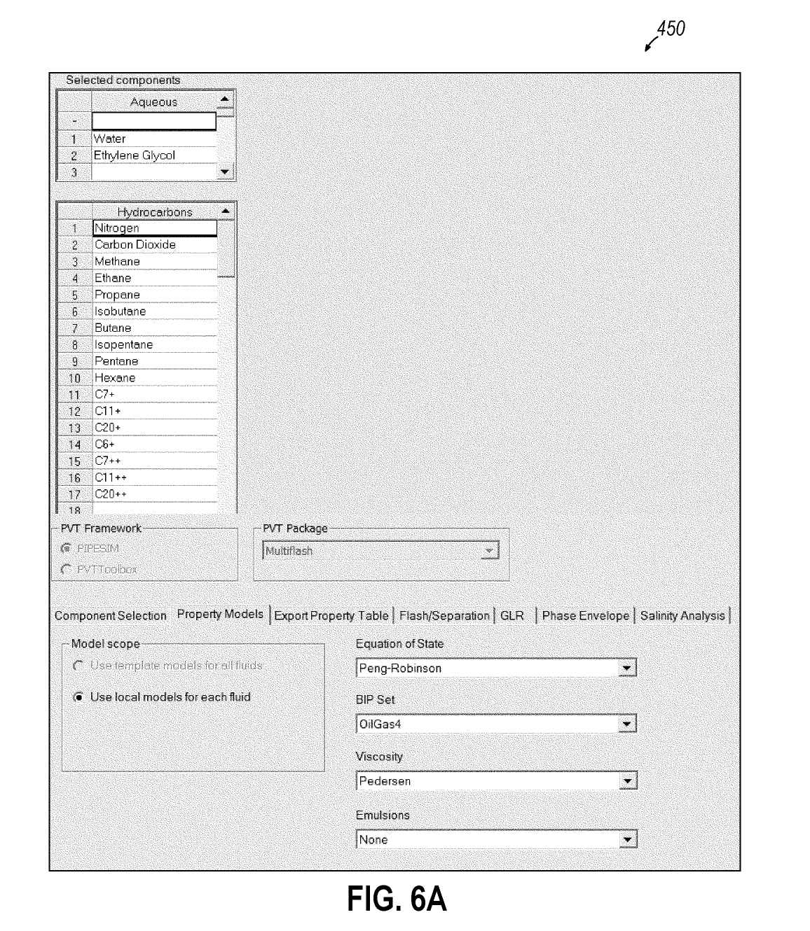

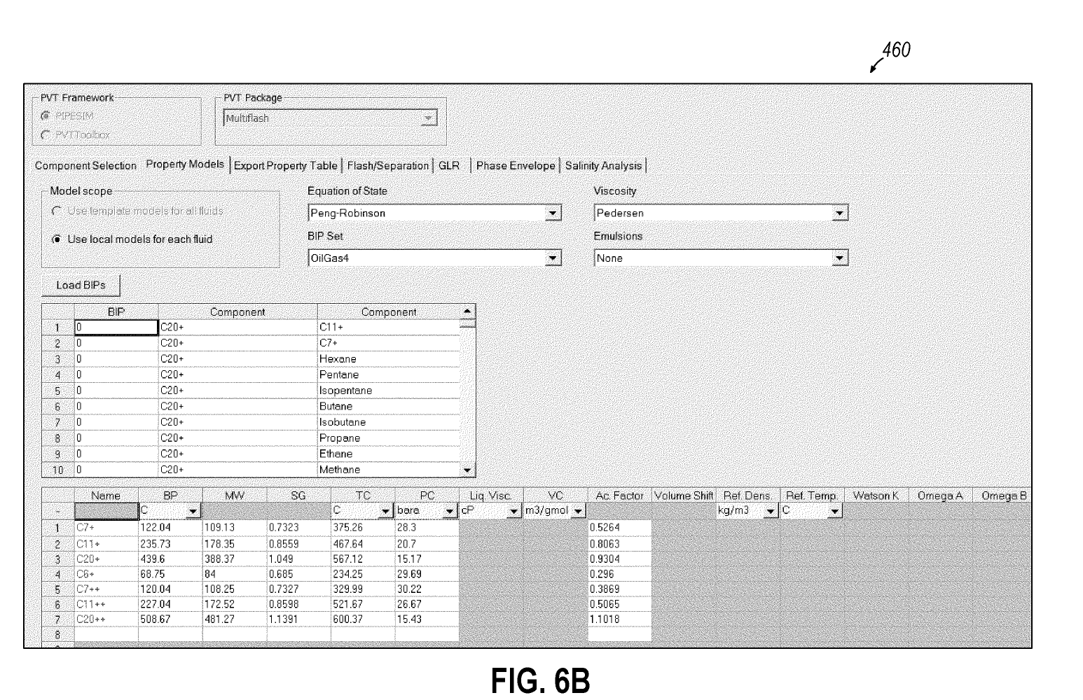

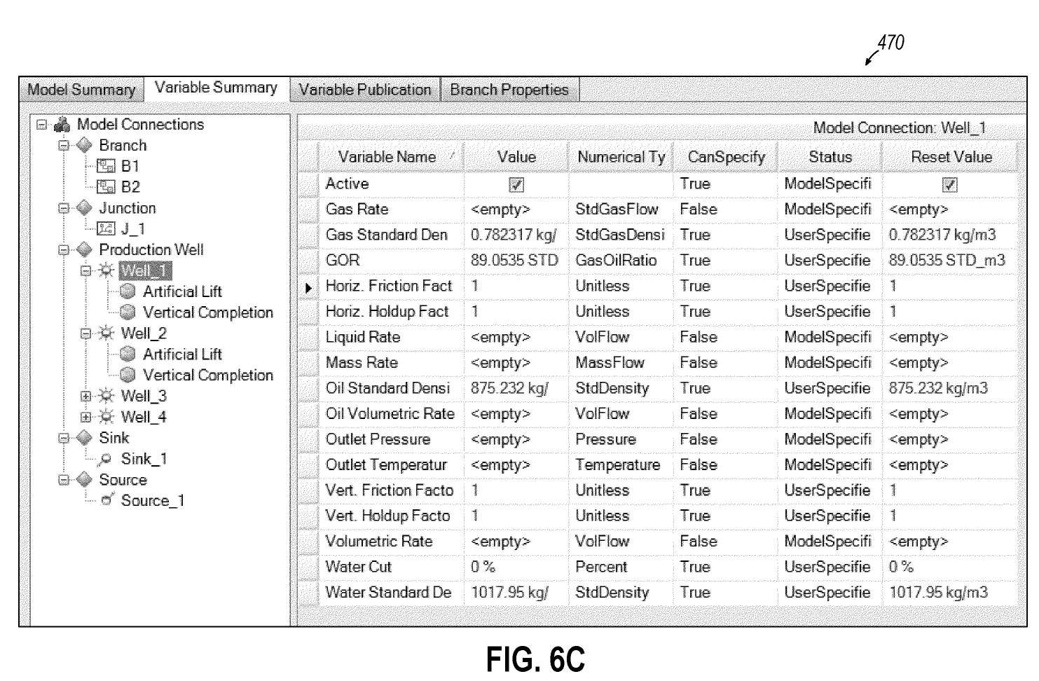

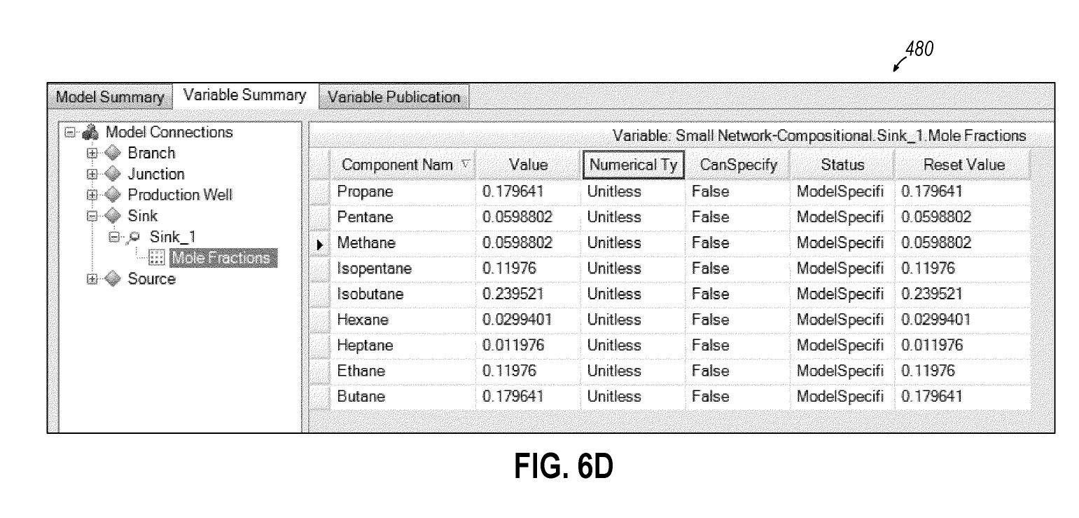

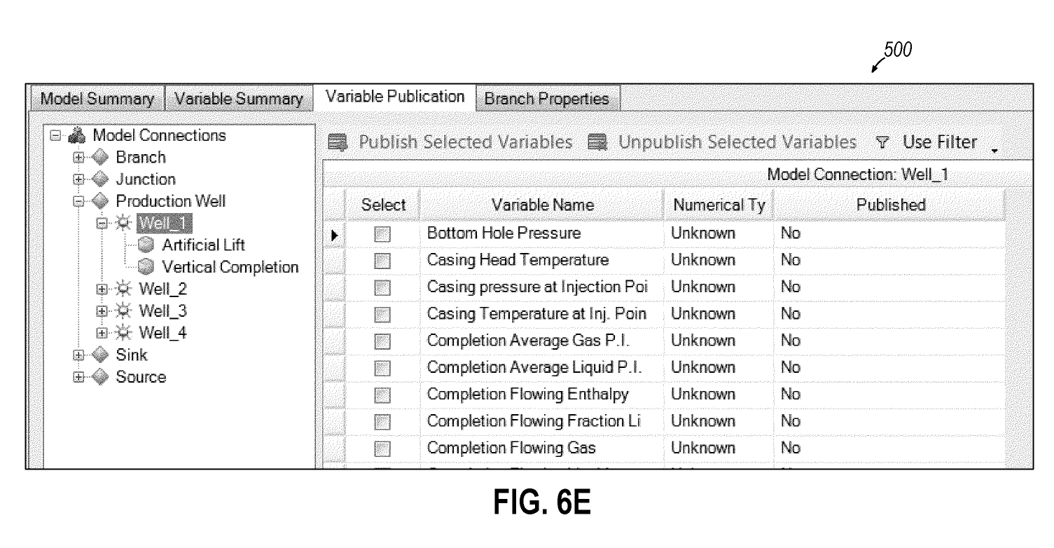

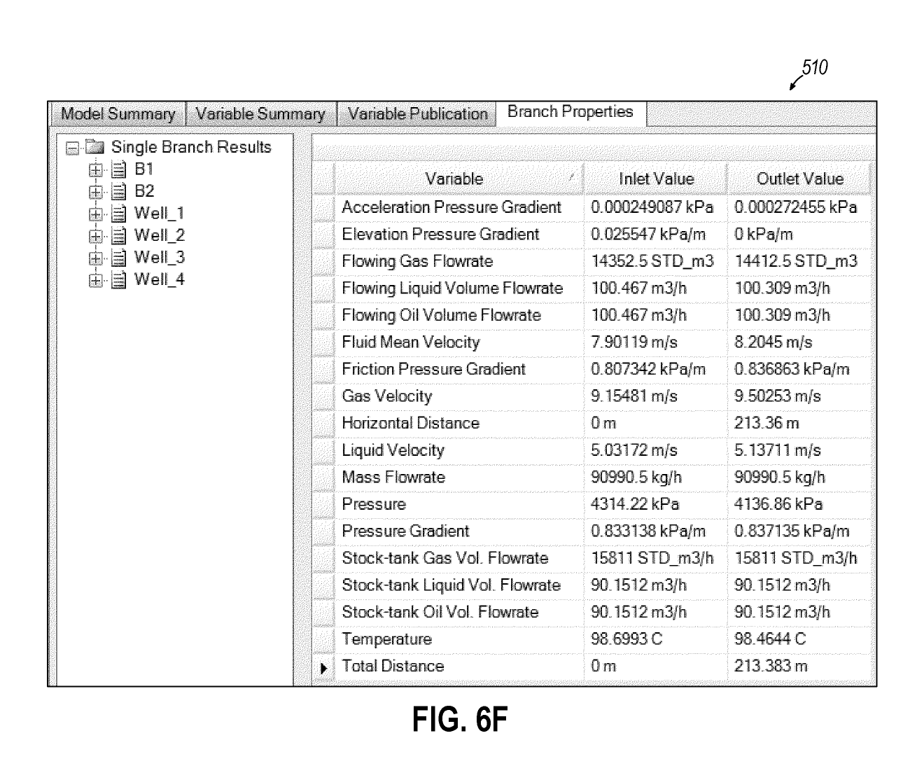

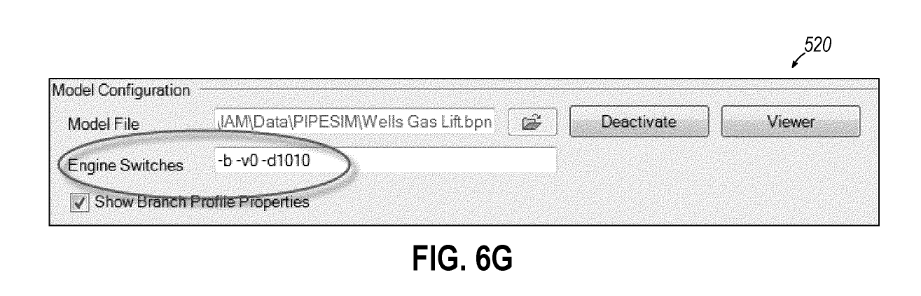

FIGS. 6A-6G provide diagrammatic illustrations of example graphical user interfaces 450-520 that may be output on a display connected to the system 10 during interface with a user. As shown in FIGS. 6A and 6B, one or more compounds may be selected for importation to the network asset model. Furthermore, binary interaction parameters (BIPs) for an equation of state thermodynamic model, components and/or properties for petroleum fractions may be extracted. In FIG. 6C, a user may interface with the graphical user interface 470 to determine configurations for network components (e.g., branches, junctions, wells, sinks, sources, etc.) as well as branch and well information (e.g., artificial lift and/or completion). In general, the surface network production model may be queried to determine configuration information. A user may identify inputs for a steady state model, where such inputs may be determined form the surface production network model. Predefined properties for the surface production network model may be set via the graphical user interface 470 to match fluid management strategies for the network asset model. In FIG. 6D, compositional networks may display composition at key nodes, where the option may be through variable publication based on user preference. Compositions may be displayed in a table format with components, where such components may be ordered as defined in the corresponding fluid.

Consistent with embodiments, the asset modeling platform 34 may support one or more variables that may be queried from the surface production network model and displayed to a user via a graphical user interface output on a display of the system 10. As shown in FIG. 6E, the one or more variables may be selected by a user when interfacing with the graphical user interface 500 of the asset modeling platform 34 via the user interface 22 of the system 10. Such selection of variables may be referred to as variable publication. User selected variables may be utilized as user defined variables for fluid management strategies, logic implementation, and/or reporting. In general, variables for the asset modeling platform 34 may be consistent, whether input/analyzed with compositional and/or black oil based models and/or whether the surface production network model is coupled to a reservoir model based simulation. As shown in FIG. 6F, a user may select branch properties for display by the asset modeling platform 34 via a graphical user interface 510. Furthermore, as shown in FIG. 6G, the asset modeling platform 34 may cause a graphical user interface 520 to be generated that allows a user to set switches, where switches correspond to simulation engine options that may be interpreted during execution for enabling features of the asset modeling platform 34.

As discussed, consistent with embodiments, during retrieval and/or selection of a surface production network model, one or more visualizations corresponding to the surface production network model and/or reservoir model may be generated and output to a display connected to the system 10. For example, a three dimensional visualization, a two dimensional visualization, and/or map visualizations may be generated. Via a graphical user interface generated by the asset modeling platform 34, tabulated data that includes values and/or characteristics for network components may be determined and output. Furthermore, a user may select one or more entities/network components (e.g., wells, nodes, branches, etc.) for review, where values for such selected entities/network components may be output on a graphical user interface for the user. In general, such values and/or characteristics may comprise grouping values such as rates, temperatures, and/or pressures.

In some embodiments, generating the one or more visualizations may include converting the surface production network to a common coordinate system of the network asset modeling platform 34. For example, the coordinate system of the surface production network may be converted to a coordinate system of a reservoir model loaded into the network asset modeling platform 34. In addition, the one or more visualizations may include topology information and results. Furthermore, the one or more visualizations may comprise property values for the surface production network model. For example, pressure gradients may be indicated in the one or more visualizations. Other such property values include, for example, erosional velocities, mixture velocities, temperatures, pressures and phase rates. The one or more visualizations may include results in table and/or plot views, where such results may comprise identifying high or low pressure regions in the system, identifying trends in the production profiles, well status (e.g., open to shut, etc.). In some embodiments, changes to the surface production network model may be displayed in the one or more visualizations when forecasting oil and gas production based on the surface production network model.

Consistent with some embodiments, a steady state simulation of the surface production network model may be performed, where any changes to properties of the surface production network model may be reflected in one or more visualizations. In general, the steady state simulation may be performed to determine characteristics of the surface production network model that may be used to build a network asset model. For example, the steady state simulation may be performed to determine capacity constraints prior to integrating the surface production network model with the reservoir model. Such characteristics may indicate, for example, why wells do not flow under backpressure from the surface production network model. A user may input/update variables used in the steady state simulation. In some embodiments, the one or more visualizations may be updated with new results and/or indications of changes responsive to a user updating the variables. Input variables may be parameterized for running sensitivities on the surface production network model, where a user may vary one or more input variables to determine a response of the surface production network model. Moreover, running sensitivities at different input variable values may be performed by the system 10 and asset modeling platform 34 to determine optimal operating inputs.

Furthermore, fluid management strategies may be defined for the surface production network model and the reservoir model. In general, fluid management strategies may comprise a history strategy, a depletion strategy (e.g., black oil and compositional), a water/gas flood strategy, depletion strategy with actions (e.g., shutting completions on wells, black oil and compositional, and/or economic limits), compositional gas re-injection strategy, drilling queues and operating targets, and/or thermal strategy with multi-segmented wells.

A network asset model may be built based on a surface production network model and a reservoir model by the asset modeling platform 34, where fluid transitions may be mapped between the reservoir model and the surface production network model based at least in part on characteristics, values, and properties determined for the surface production network model upon retrieval of the surface production network. Consistent with some embodiments, mapping the well objects of the surface production network model to the reservoir model may comprise user input of reconciling data and/or automated mapping of reconciling data, where such reconciling data may be based on characteristics, fluid properties, operational values, and/or other such relevant data associated with the surface production network model and/or the reservoir model.

Fluid transitions between the reservoir model and surface production network model may be described/represented in terms of pressure, volume, and/or temperature values. Moreover, a compositional mapping of properties between fluids may operate on a super set of components which represents a master list of components describing the fluid in the production system (e.g., methane, oxygen propane, etc.). Generally, the components may vary based on reservoir, surface production network, and/or facilities. Individual fluids may be mapped to the compositional fluid super set. For example, a reservoir fluid (BO) may be delumped into a composition as defined in the super set. From the super set of components, the information may be lumped or delumped into fluids for the surface production network. Transitions to and from the super set may be performed by the asset modeling platform 34. Generally, the surface production network fluid corresponds to the super set fluid. Information passed between the models during balancing of the reservoir and network may be logged in one or more reports. Furthermore, fluid transitions may be displayed as results in one or more visualizations for review by a user.

Determined fluid transitions may comprise black oil reservoir to black oil surface production network. Consistent with some embodiments, black oil to black oil fluid transitions may be determined by communicating Black Oil properties for all nodes. Black oil properties may be transferred to/from the surface production network model boundary streams and may include phase densities, gas-oil ratio (GOR), and/or water cut. In addition determined fluid transitions may comprise black oil reservoir to compositional surface production network. Based on a selected fluid management strategy, network components and/or fluid parameters may be updated from compositional and/or fluid information of the reservoir. For example, stock tank densities and/or viscosity values may be updated in one or more network components.

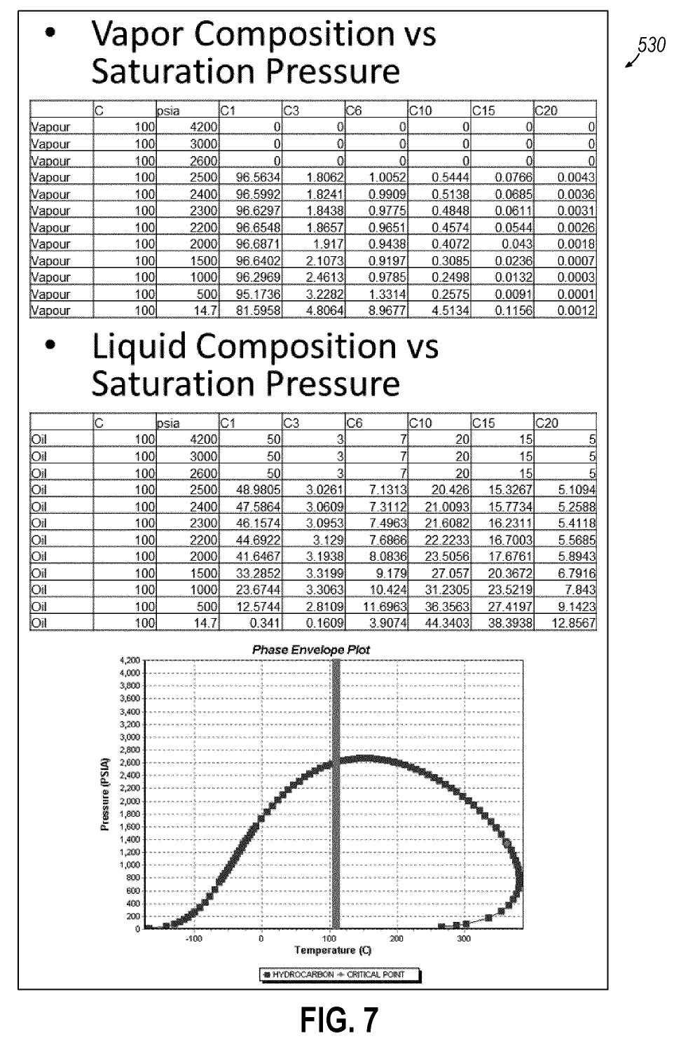

Furthermore, determined fluid transitions may comprise black oil reservoir to compositional network. Pressure, volume, and temperature management may be performed where a reservoir represented by the reservoir model comprises oil, gas, and water phases, and a surface production network represented by the surface production network model comprises fluid that includes hydrocarbons modeled compositionally into K components and water. Water may be treated as phase and network fluid may be treated as a superset of components. One or more tables and/or plots may be generated, where oil/gas versus density, liquid vapor versus saturation value, and/or liquid vapor versus saturation pressure may be determined. Black oil de-lumping may be applied to hydrocarbon phase K components. FIG. 7 provides an example chart 530 that illustrates black oil de-lumping applied to the hydrocarbon phase K components.

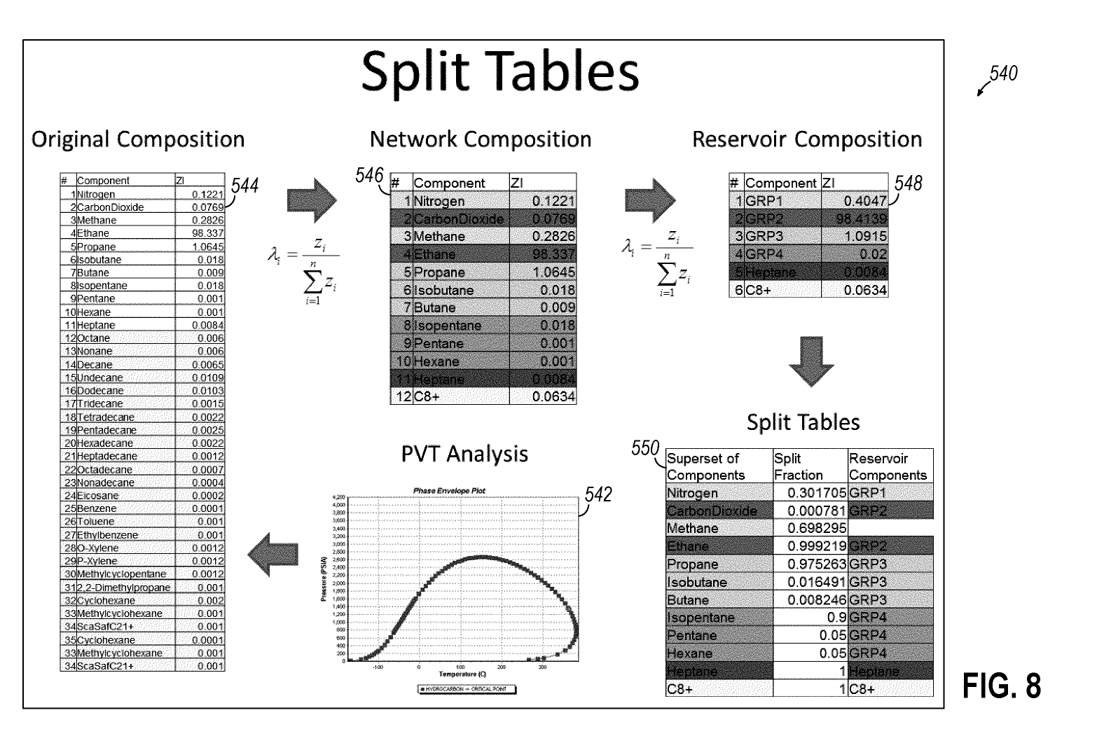

In some embodiments, a determined fluid transition may comprise compositional N components reservoir to compositional K components network. Pressure, volume, and temperature management may be performed for two sets of fluids—i.e., the reservoir fluids including N components and the surface production network fluids including K components. The network fluids may be designated a superset of fluids. Based on user input, components may be mapped/distributed between the two fluids. The distribution from the reservoir fluids to the network fluids may be performed on a mole basis, such that mass transfer may not be preserved. In other embodiments, distribution may be performed on a mass transfer basis. If multiple fluids are in the reservoir, then each fluid may be associated with one or more corresponding entities/network components (e.g., wells, groups) and each fluid may be mapped to a superset network fluid. FIG. 8 provides a flowchart 540 that illustrates a sequence of operations that may be performed to determine a fluid transition for compositional N components reservoir fluid to compositional K components network fluid. As shown, a pressure, volume, temperature analysis (block 542) may be performed to determine a fluid composition (block 544). The fluid composition (blocks 544) may be analyzed to determine a network composition (block 546) and a reservoir composition (548), and a split table (block 550) comprising a superset of components for the network may be determined.

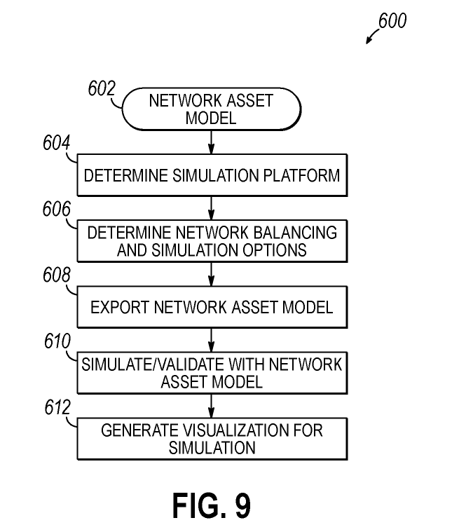

Turning to FIG. 9, this figure provides a flowchart 600 that illustrates a sequence of operations that may be performed by the system 10 consistent with some embodiments and based on a network asset model (block 602). In general, the network asset model generally comprises reservoir information integrated with surface production network information. The system 10 may determine a simulation platform to use with the network asset model (block 604). In general, a user may input one or more simulation preferences that define a time basis and/or diagnostics for performing a simulation with the network asset model. Furthermore, the user may select one or more remote host computing systems and/or one or more storage locations for storing and/or retrieving relevant data. Consistent with embodiments, the asset modeling platform 34 may cause the system 10 to generate a graphical user interface for display such that a user may input one or more simulation preferences and/or remote resources. In addition, a user may distribute simulation related tasks among one or more processors of one or more remote computing systems. For example, a user may select a first processor for executing asset management operations, and the user may select a second processor for executing simulation run operations.

Display, network balancing, and/or simulation options for performing a simulation using the network asset model may be determined (block 606). Consistent with some embodiments, the asset modeling platform 34 may generate a graphical user interface for output such that a user may set balancing parameters/constraints on one or more well objects of the network asset model. In some embodiments, a user may couple the surface production network of the network asset model to a reservoir of the network asset model by selecting, for each well object, a coupling location and/one or more coupling parameters/constraints. Furthermore, a user may define a balancing location for the coupled well object, either a top hole or bottom hole. The user may define one or more balancing constraints, including, for example, gas rate, oil rate, water rate, liquid rate, volume rate, top hole pressure, bottom hole pressure, etc. The user may select a balancing, and the user may specify properties that may be reported/recorded during simulation. Generally, the balancing algorithm may control the convergence of pressure and flow between the reservoir and the network well models. As will be appreciated, not all oil and gas producing systems are alike, so a number of balancing algorithms may be deployed to be used in fit for purpose use. Such balancing algorithms may be based on passing rates and/or inflow performance relationship (IPR) based data between the models. For example, an obey eclipse balancing algorithm pass rates from the reservoir wells to the network wells. Pressures may be checked for convergence otherwise the rates may be decreased until pressure converges. For IPR based balancing algorithms, there are generally three main types, full IPR, straight line IPR (or PI) and an IPR based on a 9 block average within the reservoir. Each algorithm may correspond to a difference in rigor. The IPR based approach may be implemented such that the IPR may be passed from the reservoir to the network. The pressure and rates determined in the network may be set as constraints in the reservoir to maintain pressure flow balance.

In some embodiments, the network asset model, including an associated surface production network model and/or reservoir model may be exported and/or saved for performing simulation (block 608). The exported surface production network model may comprise any changes selected by the user when the surface production network model was loaded into the asset modeling platform 34. Consistent with some embodiments, the exported surface production network model may not be compatible with a stand-alone surface production network model viewing platform. One or more properties of the surface production network model that is integrated into the network asset model may be configurable by a user in the asset modeling platform 34 via one or more generated graphical user interfaces. Similarly, the reservoir model associated with the network asset model may be exported and saved such with changes made from the asset modeling platform 34 reflected in the exported reservoir model.

The system may perform a simulation and/or validation of the simulation using the network asset model based at least in part on the user input variables, parameters, and/or constraints (block 610). During and after simulation, the asset modeling platform may generate one or more visualizations for the surface production network and/or reservoir of the network asset model (block 612). In some embodiments, the simulation may be a steady-state simulation. In general, the network asset model may be validated and a reservoir and/or network simulation case may be generated. The simulation using the network asset model may be visualized (topology and results) via one or more visualizations output via graphical user interface generated by the asset modeling platform. The visualizations may include results and/or operational data determined during the simulation. In addition, a simulation of the surface production network and/or the reservoir may be stored separately, such that the simulations may be processed, reviewed, and/or edited using one or more stand-alone surface production network or reservoir modeling platforms.

Moreover, during simulation, the asset modeling platform 34 may facilitate time step simulation responsive to user input via a graphical user interface generated by the asset modeling platform 34. For time step simulation, results and/or operational data may be stored/recorded at different time step intervals selected by the user. Furthermore, embodiments may update visualizations generated during the simulation at each time step such that a user may view the results and/or operational data for each time step. In general, time step parameters may be configured by the user. For example, a user may select, for a simulation, single time steps, multiple time steps, pause settings, run settings, time step interval, time step interval settings for different periods of a simulation, etc. Similarly, a user may define a start and end date for the asset modeling simulation.

Furthermore, results may be captured via one or more summary vectors and one or more elements of a visualization may be based at least in part on such summary vectors. Results may be stored for comparison with results of one or more other visualizations, such as plotting current simulation results against previously stored simulation results. In addition, diagnostic information corresponding to balancing of the surface production network and/or reservoir may be determined. Such diagnostic information may be exchanged between one or more simulation engines such that solutions for the reservoir and surface production network converge. If problems occur due to unstable wells such that wells are closed, diagnostic information related thereto may be recorded for review by a user. Information exchanged between one or more simulation engines may be stored, such that the user may review such information in report format. Such information may include fluid transition results. The diagnostic information may be stored for each well object and grouped into related well objects.

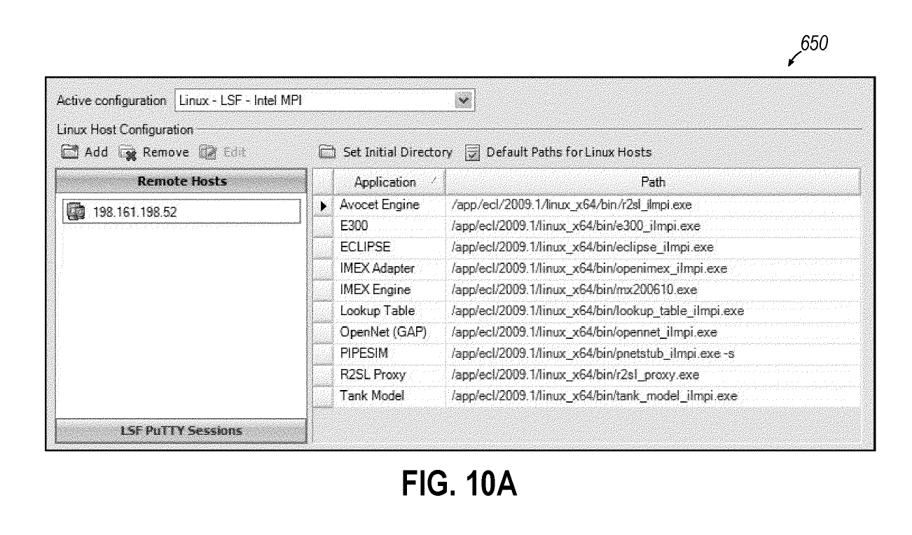

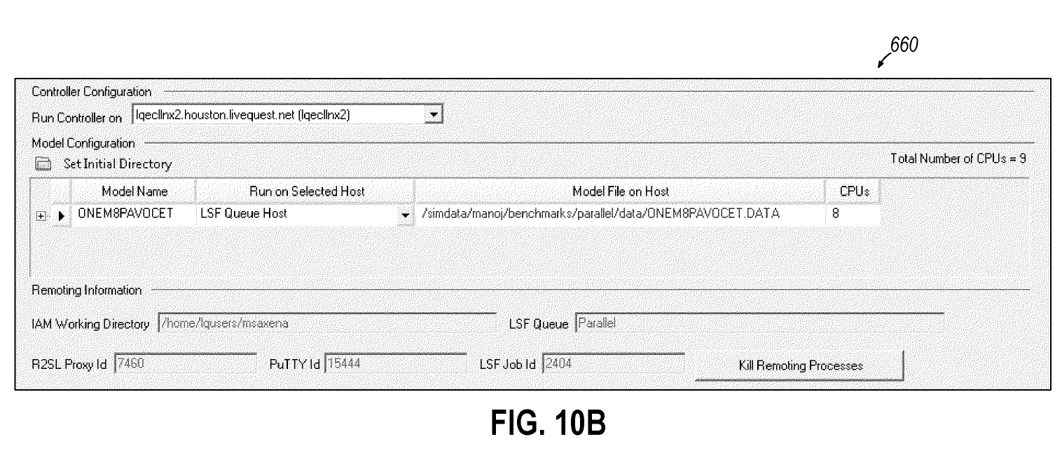

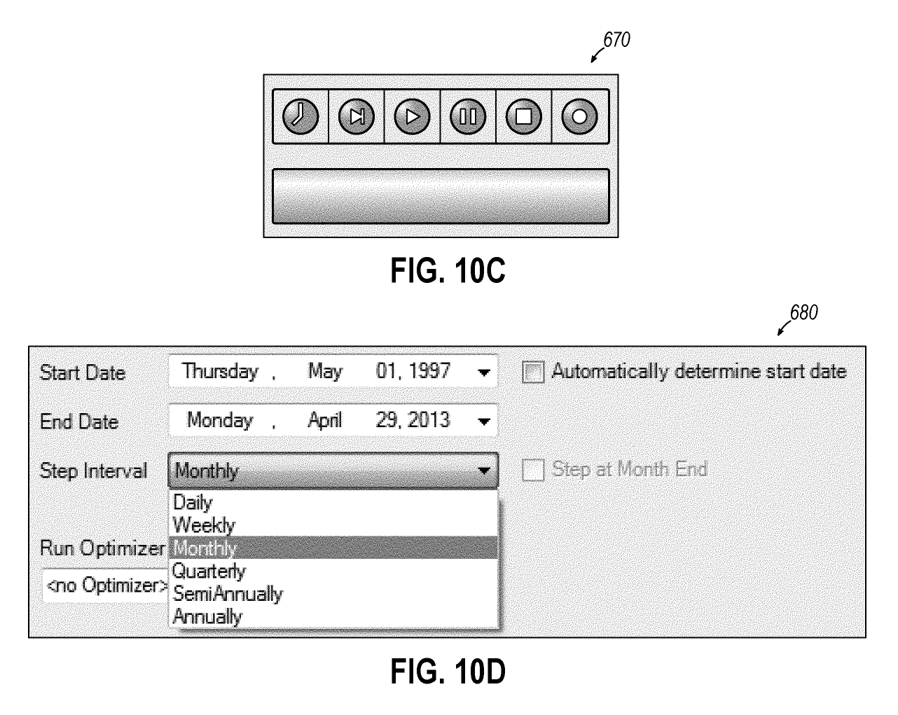

FIGS. 10A-D provide diagrammatic illustrations of example graphical user interfaces 650-680 that may be output on a display connected to the system 10 prior to and during a simulation to visually represent the simulation, results and/or operational data, as well as to interface with the user to receive user input corresponding to simulation parameters/settings, simulation platform information, etc. FIG. 10A provides an example graphical user interface 650 that may be output to a display to facilitate interface with the user to receive user input corresponding to a simulation platform, distributed processing settings, and/or remote processing systems to be utilized during simulation for one or more simulation engines. FIG. 10B provides an example graphical user interface 660 that may be output to a display to facilitate interface with the user to receive user input corresponding to remote processing systems that a user may select for performing various tasks/operations associated with simulation and/or validation. FIG. 10C provides an example graphical user interface 670 that may be output to a display to facilitate time step control by a user during a simulation. FIG. 10D provides an example graphical user interface 680 that may be output to a display to facilitate interface with the user to receive time step settings and/or time settings for a simulation.

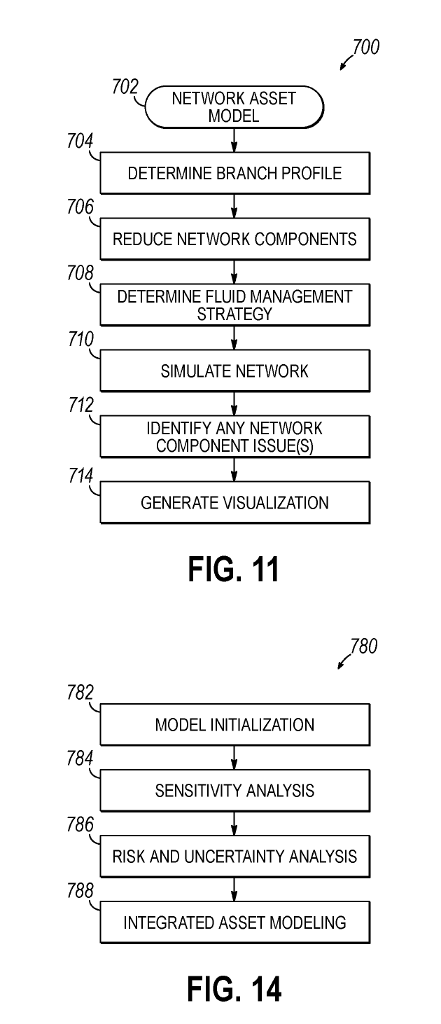

Turning now to FIG. 11, this figure provides a flowchart 700 that illustrates a sequence of operations that may be performed by the system 10 of FIG. 1 to condition a network asset model (block 702) consistent with some embodiments. In general, detail included in a surface production network of a surface production network model and/or a network asset model may exceed requirements for asset modeling and/or forecasting. For example, branches of network components of a surface production network represented by a surface production network model and/or network asset model may comprise hundreds to thousands of points (e.g., network components, nodes, etc.) that define a branch profile. For simulation purposes, each point may increase processing resource usage and/or processing time for a simulation. In some embodiments, therefore, the system 10 may condition the network asset model and/or surface production network model to determine branch profiles (block 704) for one or more branches of network components associated with a surface production network. Based on a determined branch profile, network components of a branch of the surface production network may be reduced (e.g., simplified for simulation purposes) (block 706). By reducing/simplifying network components of one or more branches of the surface production network the network asset model may be a “fit for purpose model” such that processing resource usage and/or processing time may be reduced. For example, a branch of a surface production network of a surface production network model and/or network asset model may be reduced to a straight line defined with branch properties representative of the network components of the branch for simulation purposes.

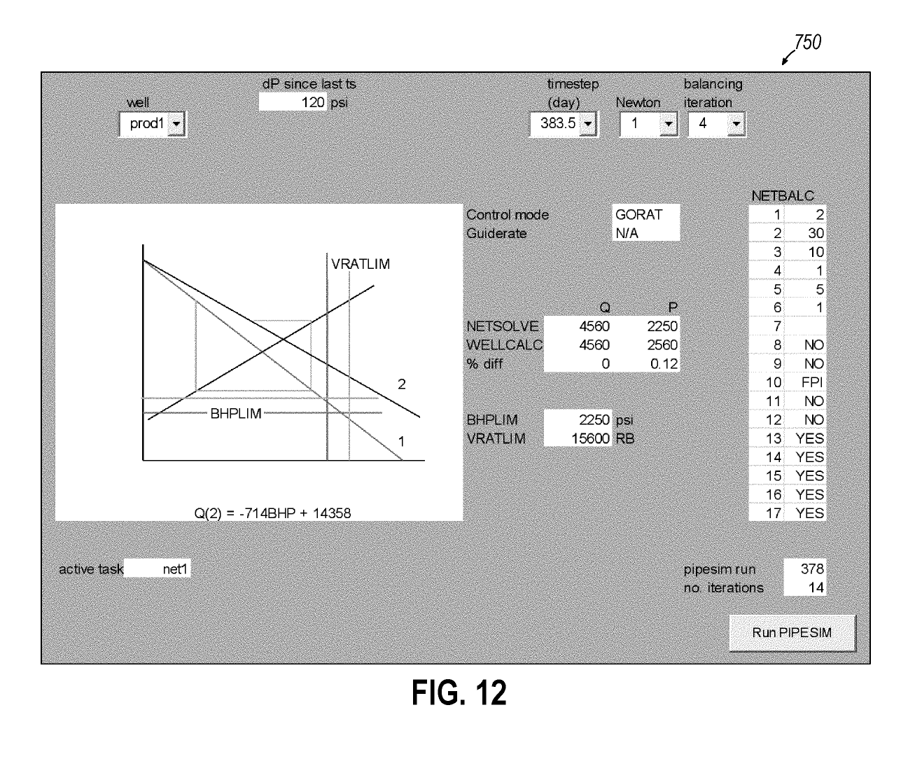

Generally, a simulation may be controllable based on events that may occur during balancing, where events include, for example, failure to converge, well fails to flow, pressure and/or flow mismatch. Consistent with embodiments, controls may be dynamically set that notify a user during a simulation. For example, the asset modeling platform 34, during execution and while performing a simulation may, stop on event, stop and ask for confirmation to continue, and/or report and continue. FIG. 12 provides a graphical user interface 750 that may be generated by the asset modeling platform 34 upon execution by a processor to output for user review diagnostic information for diagnosing balancing at the well level.

Returning to FIG. 11, the user may input information that defines one or more asset level fluid management strategies (block 708). For each fluid management strategy, the system may build one or more network asset models and/or run one or more simulations (block 710). Based on the results from the one or more simulations, embodiments may condition the network asset model. Using the one or more simulations, the system may generate alternative scenarios and/or generate visualizations based thereon. For a simulation, the asset modeling platform 34, upon execution, may identify one or more network component issues (block 712), where such network component issues may be included in one or more indicators in one or more visualizations for review by a user (block 714). For example, embodiments may identify flow and pressure constraint issues for network components or branches. Based on the identified issues, a user may close wells, reroute branches, add additional equipment, etc. to remove bottlenecks and/or revamp.

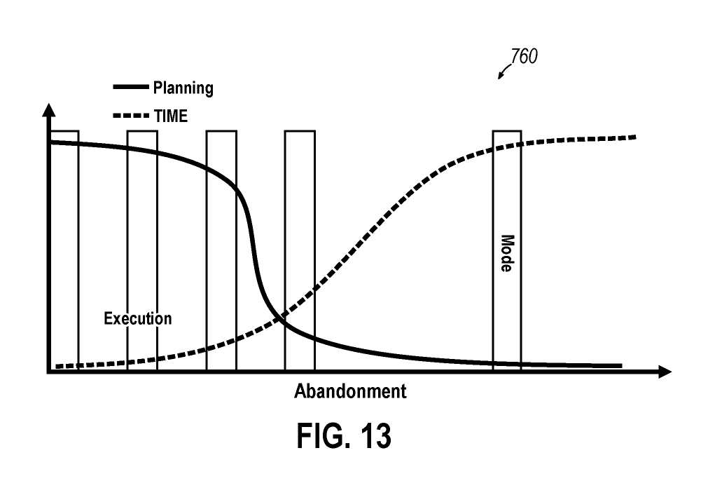

Similarly, facilitating one or more simulations may be utilized in determining field development plans. For example, results, diagnostic information, and/or visualizations from one or more simulations may be exported in a format that may be loaded and processed by a field development platform. Generally, field development planning professionals face the challenge of making resource expensive decisions based on limited information in the face of many uncertainties. For example, technical, economical, legal/contractual, and/or political uncertainties often add complexity to field development planning for oil and gas production systems. Some field development planning professionals employ front end loading (FEL) methodologies which includes comprehensive planning and design early in a development project's lifecycle. Therefore, results, diagnostic information, and/or visualizations determined from the models may provide increased information sources during FEL methodology based field development planning. FIG. 13 provides an example chart 760 that illustrates a FEL based field development plan, where, as illustrated FEL accounts for project risk at the design stage to maximize project value and minimize unexpected outcomes.

During field development planning, professionals generally consider major uncertainties and how to manage such uncertainties and quantification/consideration of risk. Such considerations may be used to judge between hundreds to thousands of field development plan scenarios. Embodiments may be utilized by field development plan professionals to process various simulations for scenarios to identify representative scenarios, which may be further refined and analyzed using the asset modeling platform 34. FIG. 14 provides a flowchart 780 that illustrates a workflow that may be performed by embodiments for field development planning. As shown, a model may be initialized by retrieving and/or building a surface production network model and a reservoir model (block 782). Sensitivity analysis may be performed on the initialized model (block 784), where sensitivity analysis may include identifying uncertainty variables and/or determining one or more development scenarios. Risk and uncertainty analysis may be performed (block 786), where the analysis may include one or more simulations for one or more development scenarios to log results and determine values for uncertainty variables based on a development scenario. Based on the risk and uncertainty analysis, a user may interface with the asset modeling platform to perform integrated asset modeling (block 788) for one or more selected development scenarios to determine optimization variables as well as one or more operating parameters for the development scenarios.

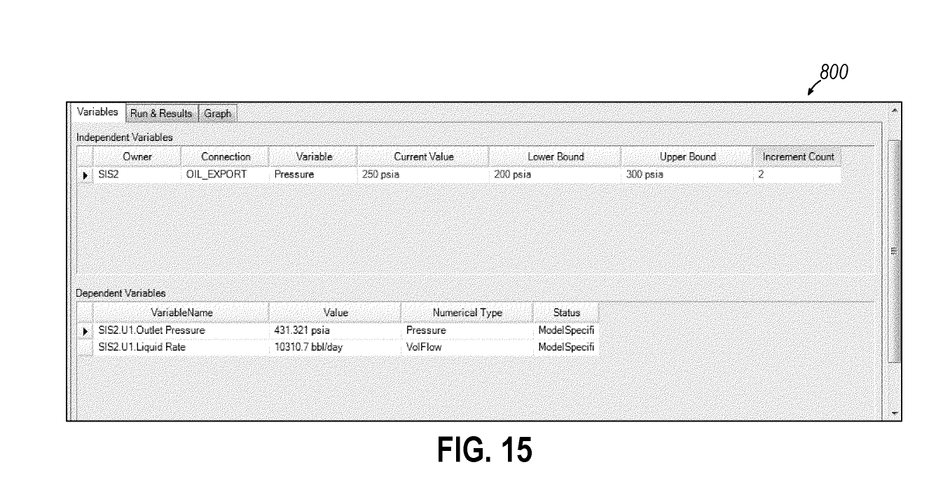

Consistent with embodiments, sensitivity simulation and analysis may be performed for a surface production network model and a reservoir model for one or more scenarios, where each scenario may be configured with a separate surface production network model and reservoir model. The asset modeling platform may generate one or more graphical user interface driven menus such that a user may select independent and dependent variables and select one or more results data output options. FIG. 15 provides a diagrammatic illustration of an example graphical user interface 800 that may be generated to facilitate user input of variables and/or select one or more output formats for results data from a sensitivity run for a scenario. A user may input, for each independent variable, a base value, an upper bound, a lower bound, and/or increment values. A user may specify dependent variables for which results data is desired as well as a format in which such results data may be output. For example, total production related data, net present value (NPV) data and/or a related equation, and/or other such dependent variables.

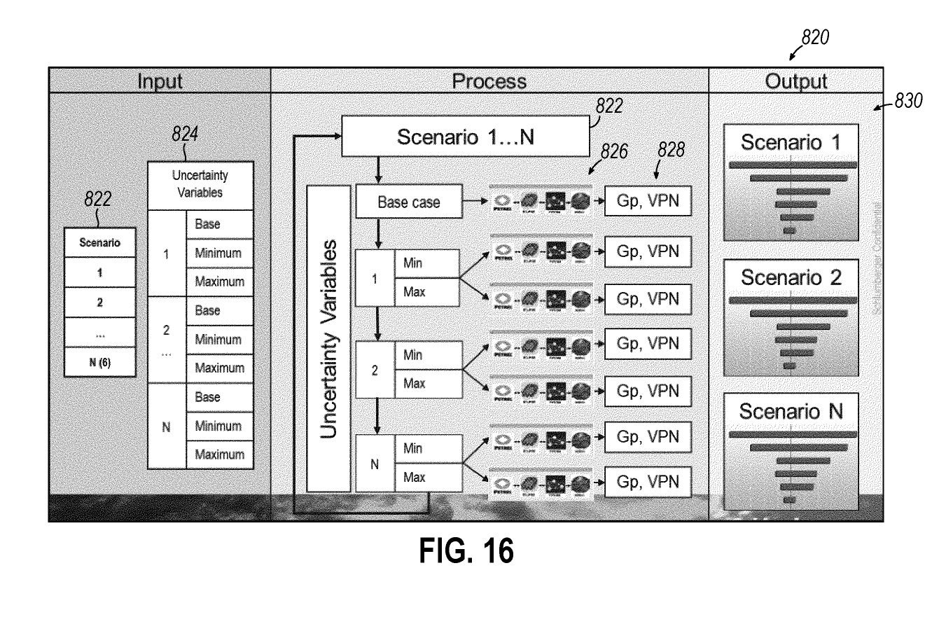

For one or more scenarios, multiple integrated model sensitivity runs may be performed corresponding to the base case of all variables, and lower and upper bounds of each variable as shown in the figure below. In some embodiments, for each simulation, each uncertainty variable may be set to min value and then to max value holding all other values at their base values. For example, FIG. 16 provides a diagrammatic illustration of an example input, process, and output workflow 810 that may be performed for one or more simulation scenarios consistent with some embodiments. As shown in FIG. 16, for one or more simulation scenarios 822 and one or more uncertainty variables 824 (for which a base value, minimum value, and/or maximum value may be specified), embodiments may perform one or more simulations using one or more modeling and/or analysis platforms 826 to determine results data 828 for each scenario and/or uncertainty variable. The results data 828 may be output and/or stored 830 in one or more formats selected by the user.

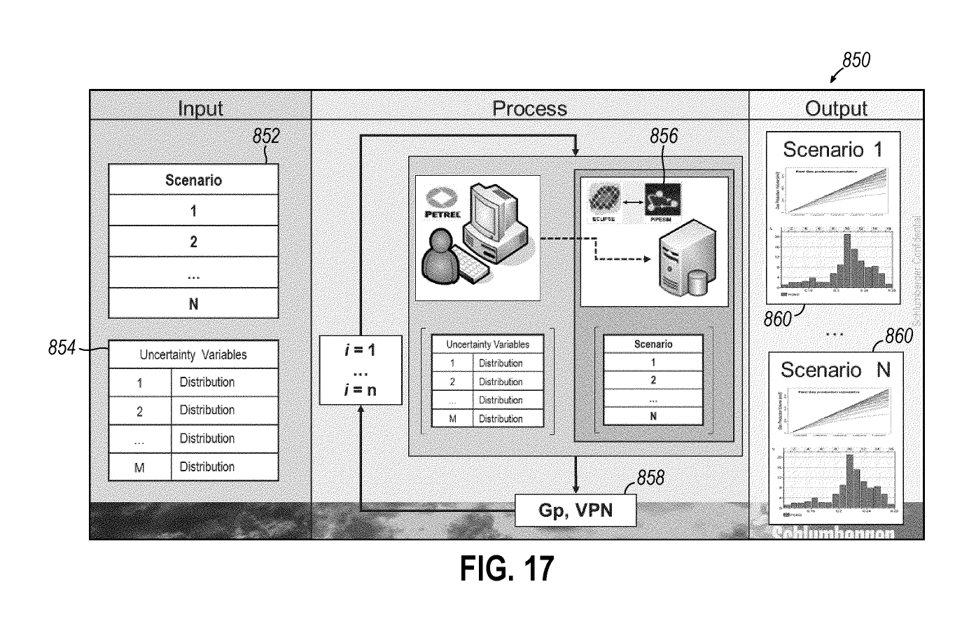

The results data from sensitivity simulations, such as those described with respect to the workflow 820 illustrated in FIG. 16 may be analyzed to determine high sensitivity variables. The high sensitivity variables may be selected for further uncertainty analysis. Risk may be identified by understanding how the distribution of these high sensitivity variables in the integrated network asset model and simulations based thereon affect different scenarios. The multiple scenarios may be defined, and each scenario may include a separate reservoir model and one or more network models associated with an integrated network asset model. A different distribution may be defined for each high sensitivity variable. For example, normal, skew normal, triangular, bounded, uniform etc. A Monte-Carlo simulation pick may be performed for each variable used for each asset modeling run. After performing a plurality of simulation runs (e.g., hundreds, thousands, etc.), results data for key performance indicators (KPIs) (oil production, NPV, etc.) may be plotted in two dimensional plots, three dimensional plots, and/or histograms. Comparative scenario analysis tools may be provided in the network asset modeling platform that may be used to identify the best scenario in terms of the risk-NPV values. FIG. 17 provides a diagrammatic illustration of an example input, process, and output workflow 850 that may be performed for one or more simulation scenarios consistent with some embodiments. As shown, one or more scenarios 852 and one or more distributions for one or more high sensitivity uncertainty variables 854 may be input. One or more analysis and/or modeling platforms 856 may perform simulations based on the input scenarios 852 and distributions of uncertainty variables 854 to generate results data 858 that may be output via one or more visualizations 860 (e.g., two dimensional plots, three dimensional plots, histograms, etc.).

Consistent with some embodiments, a guide rate and/or target production of a reservoir coupled to a surface production network may be determined where guide rate may work with network constraints. As an example, if there are 10 wells coupled at top-hole using full inflow performance relationship (IPR), with an oil flow rate being set on the wells as a constraint following an analysis of the surface production network. Network pressure at a sink may be fixed, and a limit may be set at the field level on the oil production rate, which may be referred to as a max oil production rate.

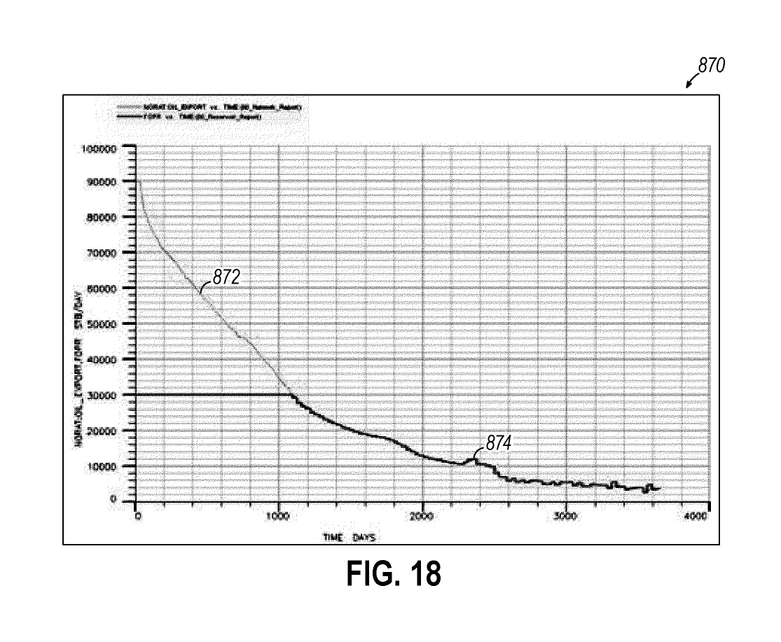

A balancing may be configured as follows: (a) network balancing—it is used to determine the network deliverability (i.e., a maximum amount of fluid that can be carried over the surface production network for the pressure imposed at the sink; and/or (b) guide rate balancing: if the surface production network deliverability is greater than the required field production limit then guide rate balancing is applied to cutback well production in order to match the imposed group limit. In this example two periods for the production profile: (1) a reservoir constrained period, where field oil production rate is equal to the field oil production limit, the field group limit is lower than the network deliverability (i.e., the network is able to handle more fluid than needed by the group limit), wells are mostly producing under group control, and network pressure distribution may be higher in this case since more fluid handled by the network during balancing than the amount of fluid effectively produced as a result of the group control cutback; and (2) a network constrained period, where field oil production rate is equal to network deliverability, the network deliverability is lower than the field group limit, and wells are mostly producing under network constraint (e.g., network back-pressure effect). FIG. 18 provides a chart 870 that illustrates results from simulation runs comprising a first portion for oil flow rate at sink 872 and a second portion for oil production rate for field 874.

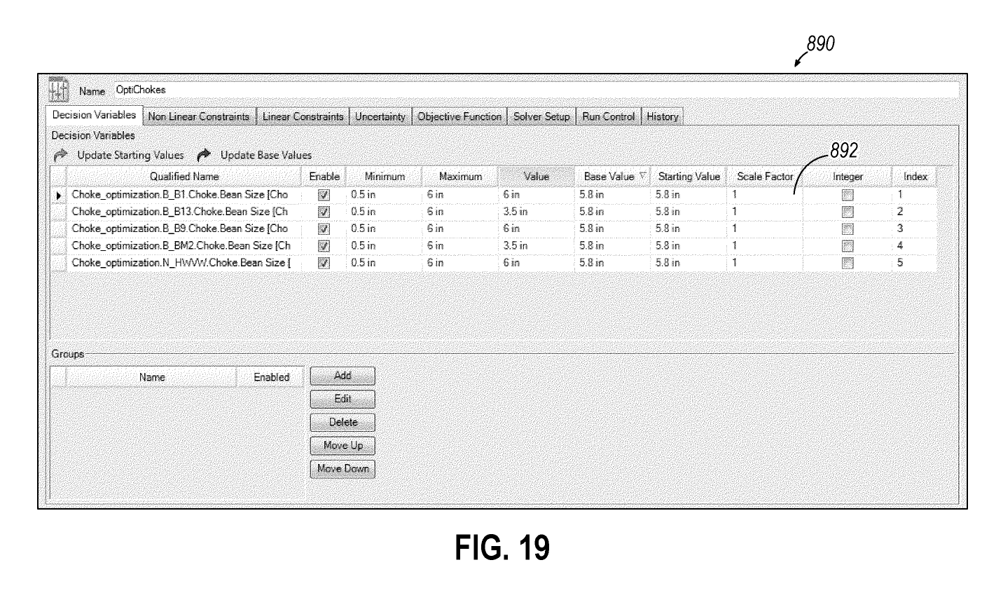

Moreover, during modeling using the integrated network asset model and/or the network asset modeling platform, users may identify alternatives of changing a branch to connect from one node to another on the surface production network. Therefore, some embodiments may generate a graphical user interface that facilitates network re-branching and/or changes to branch topology. The network asset modeling platform may perform general optimization studies and generate results data based thereon. Therefore, all input and/or output properties and/or results data may be stored in a format for the network asset modeling platform. In general, during the performance of an optimization, embodiments may determine/specify decision variables to be varied and an objective function to be optimized, where the objective function may include one or more constraints. Decision variables may be selected via a graphical user interface generated by the modeling platform, where such decision variables correspond to what may be varied during optimization to determine an optimal solution. In some embodiments, a graphical user interface generated by the modeling platform may facilitate user input of a starting value, a scale factor, minimum bounds, and/or maximum bounds for one or more decision variables. FIG. 19 provides an example graphical user interface 890 that may be generated by the modeling platform consistent with some embodiments. In this example, a user may select one or more decision variables and/or input a starting value, a scale factor, a minimum bound, a maximum bound and/or other such values via an input field 892 of the graphical user interface 890.

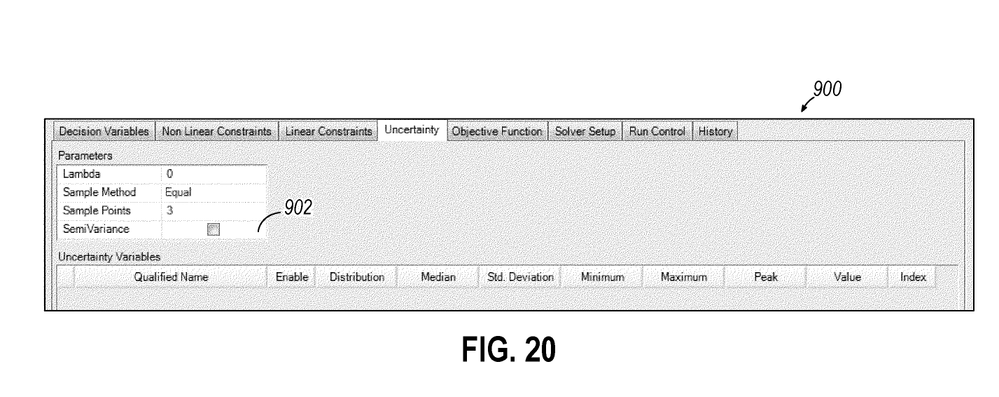

In general, non-linear constraint variables may be defined. Such variables, whose values may change during an optimization study run, are may be constrained to stay within user-defined minimum and maximum bounds. Values for non-linear constraint variables may be calculated based on other data in the optimization study. Furthermore, linear constraint variables may be defined, where each linear constraint variable may be built using one or more of the decision variables. Moreover, the linear constraint variables may be based on linear equations, where the results of such linear equations may be constrained to stay within user-defined minimum and maximum bounds. Uncertainty may be optional for an optimization study, and may be file-dependent. In general, uncertainty may allow the user to modify the objective function to take into account physical uncertainty in the integrated network asset model. An uncertain variable may be any specifiable variable that affects the initialization of the integrated network asset model, and generally excludes decision variables. For example, the user may use a liquid productivity index (PI) of a well within a surface production network model, or a plant arrival temperature within a portion of a surface production model corresponding to a gas-oil separation train. FIG. 20 provides an example graphical user interface 900 that may be generated by a modeling platform consistent with embodiments. In this example, a user may input information associated with uncertainty for an optimization study via an input field 902.

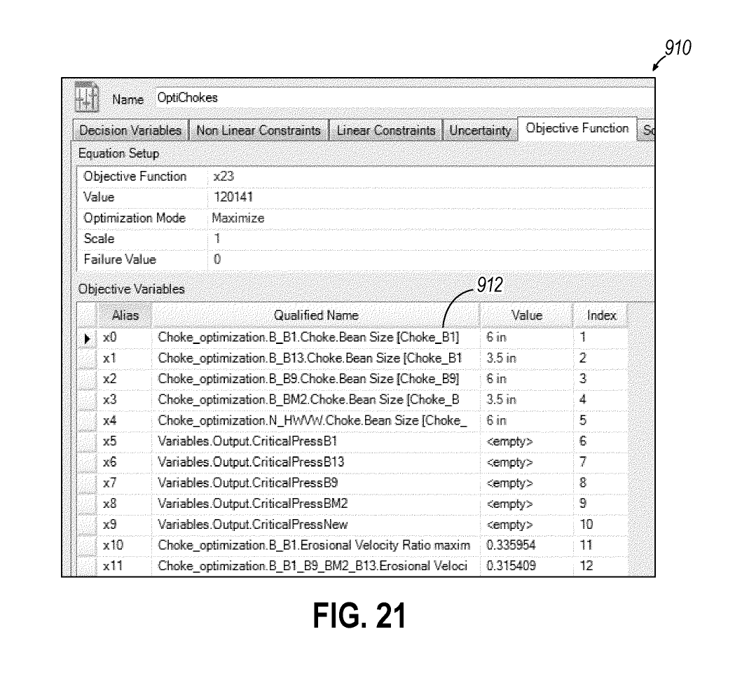

In some embodiments, a user may be able to define an objective function to minimize or maximize for the optimization study. The objective function may be based on the decision variables, or the user may define additional objective variables for use in the objective function to minimize or maximize the objective function. The objective function may reference all properties within active surface production models, reservoir models, and/or integrated network asset models on a main flow diagram, and the modeling platform may manipulate such models using an extensive range of mathematical operators and functions in order to create an equation of any desired complexity for use as the objective function. Therefore, consistent with some embodiments, one or more graphical user interfaces may be generated by the modeling platform through which the user may select and/or manipulate active models and properties thereof for creating and/or determining an objective function for an optimization study. FIG. 21 provides an example graphical user interface 910 that may be generated by a modeling platform consistent with some embodiments. In this example, a user may define one or more properties and/or objective variables 912 to thereby determine/create an objective function for use in an optimization study.

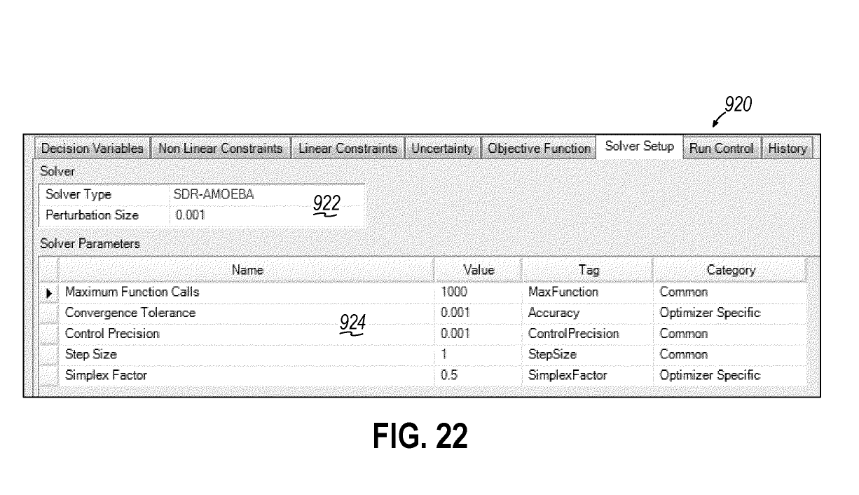

Furthermore, embodiments may support one or more optimization solving strategies (referred to as solvers). Therefore, in some embodiments, the modeling platform may generate a graphical user interface such that a user may select a particular solver to use for an optimization study. For example, the modeling platform may facilitate implementation of one or more of the following types of solvers: SDR-AMOEBA, SDR-AMOEBA-ANN, SDR-LEXICO, SDR-LEXICO-ANN, SDR-LEXICO-RBF, SDR-MINLP, SDR-MINLP-ANN, and/or SDR-MINLP-RBF. Furthermore, via a graphical user interface generated by the modeling platform, a user may specify values for one or more parameters that may control a solver's behavior, where such parameters generally vary depending on the type of solver selected. FIG. 22 provides an example graphical user interface 920 that may be generated by a modeling platform consistent with some embodiments. In this example, a user may select a solver to utilize in the optimization study via a provided input field 922 and define one or more parameters for the solver via an input field 924.

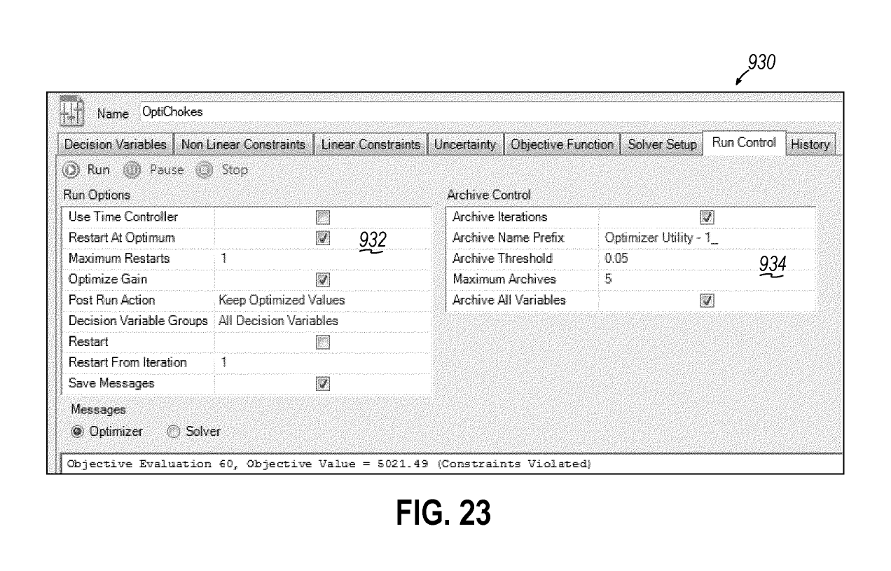

Consistent with some embodiments, a user may define how the modeling platform will process data through one or more iterations of the optimization study and how the modeling platform will store and/or display results data. FIG. 23 provides an example graphical user interface 930 that may be generated by a modeling platform consistent with some embodiments. In this example, a user may specify results data processing options via an input field 932 of the graphical user interface 930 as well as results data storage and/or visualization options via an input field 934 of the graphical user interface 930. Based on the stored results data and/or visualizations thereof, a user may view and/or manipulate graphical and/or tabular representations of such results data from an optimization study. The modeling platform may generate results data visualizations and a corresponding graphical user interface such that a user may trace iteration related results data for the objective function or any other variables as the modeling platform performs iterations of the optimization study.

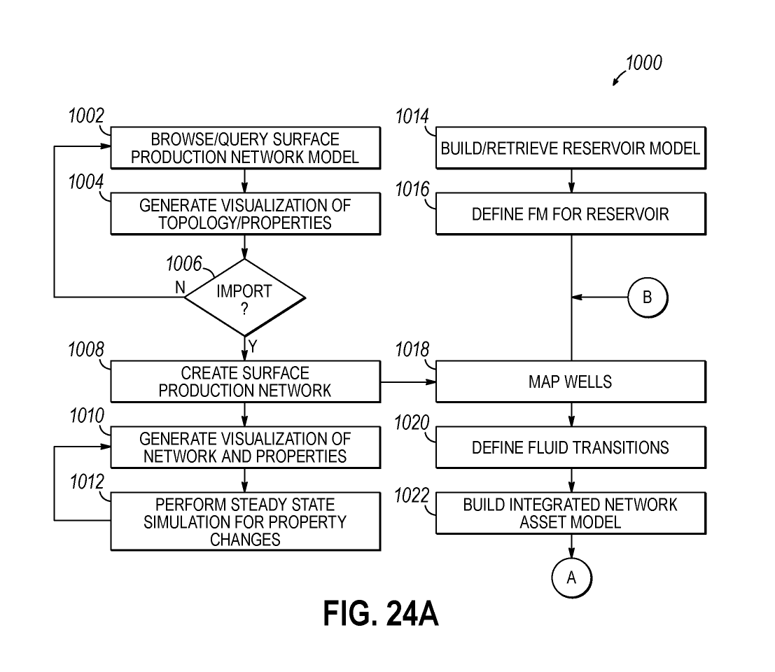

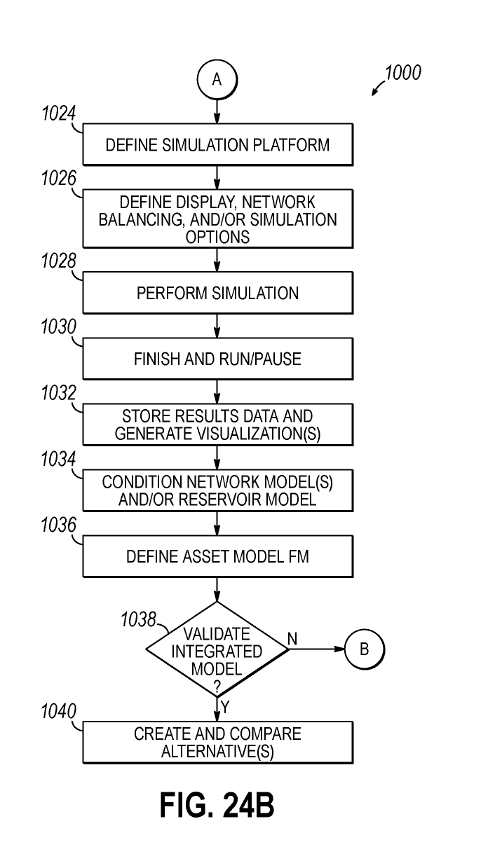

FIGS. 24A-B provide a flowchart 1000 that illustrates a sequence of operations of a workflow that may be performed. In general, the workflow illustrated by flowchart 1000 may be implemented via one or more modeling platforms, analysis platforms, applications, modules, programs, and/or other such computer implemented processing systems/devices. As described herein, one or more graphical user interfaces may be generated and output to a user for one or more of the operations illustrated for the workflow to output data for a user and/or facilitate user input of data to select relevant surface production network models, select one or more relevant reservoir models, define one or more parameters, constraints, preferences, and/or other such information relevant to building an integrated network asset model, performing one or more simulations therewith, etc. As shown in FIG. 24A, a user may browse and/or query via one or more graphical user interfaces to select one or more surface production networks (block 1002). In response to user selection, one or more topology and/or property based visualizations may be generated (block 1004) for review by a user. The user may select whether to import the selected and visualized network model (block 1006). If the user does not wish to import the selected network model, the operations of blocks 1002-1006 may be repeated to select a different network model (“N” branch of block 1006).

If the user selects to import the network model (“Y” branch of block 1006), the modeling platform creates the network model (block 1008). In general, creating the network model with the modeling platform comprises determining all network components (e.g., branches, junctions, wells, sinks, sources, etc.), creating modeling platform compatible network model and/or objects for the network components, mapping the network components to a common coordinate system, and importing any predefined properties of the network model. In some embodiments, the modeling platform may generate one or more visualizations of the created network model and any properties (block 1010). The visualizations may comprise two dimensional models, three dimensional models, map based visualizations, and/or other such types of visualizations. The modeling platform may perform a steady state simulation if any properties are modified by the user (block 1012), and the modeling platform may generate updated visualizations based on such changes (block 1010).

A user may build and/or retrieve a reservoir model through one or more graphical user interfaces of the modeling platform (block 1014). In addition, the user may define one or more strategies for field management for the reservoir model (block 1016). Based on the surface model and the reservoir model, the modeling platform maps the reservoir model to the well objects of the network model (block 1018). As discussed, the network components (including well objects) of the network model are mapped to a common coordinate system, such that the well objects may be mapped to the reservoir model. Fluid transitions between the reservoir model and the network model may be defined (block 1020), where such fluid transitions may include black oil reservoir to black oil network, black oil reservoir to compositional network, and/or compositional reservoir to compositional network. Based on the mapped wells and determined fluid transitions, the modeling platform builds an integrated network asset model (block 1022).

Continuing to FIG. 24B (via connection ‘A’), a user may define a simulation platform (block 1024). Consistent with embodiments, a user may specify one or more host processing systems through which one or more simulation tasks may be performed. In some embodiments, a user may distribute simulation tasks across processors of one or more distributed processing systems. Display, network balancing, and/or simulation options may be defined (block 1026). Generally, a user may input/define such options via one or more graphical user interfaces generated by the modeling application where the graphical user interface may be displayed via a user interface, and user input may be collected via the user interface. Options that the user may define include, for example, balancing location for each well, one or more coupling constraints, a balancing algorithm (e.g., Full IPR coupling), results data storage and reporting properties, and/or other such simulation relevant options/properties.

Based on the defined simulation platform, the network balancing, display options, simulation options, the network model, reservoir model, and/or integrated asset model, the modeling platform performs one or more simulations (block 1028). When the modeling platform finishes a simulation, when a user pauses a simulation, and/or when a user steps through a simulation (block 1030), the modeling platform stores results data and generates one or more visualizations of the integrated network asset model and/or the results data (block 1032). Based on the results data, the modeling platform may condition the one or more network models and/or the reservoir model, which in turn may be used to condition the integrated network asset model (block 1034). In general, conditioning may comprise component reduction and/or fluid property simplification based at least in part on the results data to thereby generate a more simulation efficient conditioned model. Based on the results data, the user may define one or more asset level field management (FM) strategies (block 1036). Based on the newly introduced and/or modified FM strategies, results data, the modeling platform may further condition the models.

Based on the results data for one or more simulations, the modeling platform may determine whether the integrated network asset model is validated (block 1038). In general, the integrated network asset model may be validated if during balancing and simulation, solutions for fluid transitions and modeling converge. If problems occur to due unstable wells, the integrated network asset model may not be validated. If the integrated network asset model is not validated (“N” branch of block 1038), the user may rebuild the integrated network asset model and define and/or modify properties and field management strategies (i.e., return to block 1018 via connection ‘B’). In response to validating the integrated network asset model, the modeling platform may facilitate the creation of alternative scenarios (block 1040). Such alternative scenarios may comprise de-bottlenecking scenarios, revamping scenarios, and/or different field development plan scenarios using the validated integrated network asset model.

Therefore, consistent with some embodiments, a high level workflow for oil and gas production system asset management may be provided. In particular, integrated asset management may be provided via an integrated network asset modeling platform. The integrated network asset modeling platform may facilitate step-by-step creation of one or more reservoir models and/or surface production network models, creation and/or conditioning of an integrated network asset model that is based on coupling of a reservoir model to one or more network models. Moreover, the integrated network asset model may interactively run one or more simulations and store/generate visualizations of the results. In addition, a user may evaluate alternative scenarios using different field management strategies and/or facilitate sensitivity analysis, risk analysis, and/or optimization study.

While particular embodiments have been described, it is not intended that the subject matter and/or embodiments be limited thereto, as it is intended that embodiments be as broad in scope as the art will allow and that the specification be read likewise. It will therefore be appreciated by those skilled in the art that yet other modifications could be made without deviating from its spirit and scope as claimed.

What is claimed is:

1. A method for building an integrated network asset model for an oil and gas production system, the method comprising:
retrieving, with at least one processor, a surface production network model associated with the oil and gas production system;
determining, with the at least one processor, at least one well object associated with the surface production network model;
determining, with the at least one processor, fluid properties for the at least one well object based at least in part on a reservoir model associated with the oil and gas production system; and
building, with the at least one processor, the integrated network asset model for the oil and gas production system based at least in part on the network model, the at least one well object, and the fluid properties for the at least one well object.

2. The method of 1, further comprising:
receiving user input that selects the network model from a plurality of existing network models stored in a memory.

3. The method of 2, further comprising:
generating at least one visualization of the surface production network model to be output to a graphical user interface.

4. The method of 3, wherein the at least one visualization of the surface production network model is generated prior to retrieving the surface production network model.

5. The method of claim 3, wherein the at least one visualization of the surface production network comprises a two-dimensional visualization, a three-dimensional visualization, a map based visualization, or any combination thereof.

6. The method of 1, wherein determining the fluid properties for the at least one well object comprises:
mapping a reservoir model associated with the oil and gas production network to the at least one well object.

7. The method of claim 6, wherein mapping the reservoir model to the at least one well object comprises determining a coupling location based at least in part on whether the at least one well object is included in the surface production model.

8. The method of claim 6, wherein mapping the reservoir model to the at least one well object comprises:
determining fluid transitions between the reservoir model and the at least one well object.

9. The method of claim 8, wherein the fluid transitions comprise black oil reservoir to black oil network, black oil reservoir to compositional network, compositional reservoir to compositional network, or any combination thereof.

10. The method of claim 1, further comprising:
retrieving a reservoir model associated with the oil and gas production system,
wherein the fluid properties for the at least one well object are determined based at least in part on the reservoir model.

11. The method of claim 1, further comprising:
determining at least one field management strategy for the reservoir model, wherein the integrated network asset model for the oil and gas production system is built based at least in part on the at least one field management strategy.

12. The method of claim 1, further comprising:
generating at least one visualization of the surface production network model responsive to a fluid property changing for the surface production network.

13. A system for building an integrated network asset model for an oil and gas production system comprising:
at least one processor;
a memory; and
program code stored on the memory and configured to be executed by the at least one processor to cause the at least one processor to:
retrieve a surface production network model associated with the oil and gas production system;
determine at least one well object associated with the surface production network model;
determine fluid properties for the at least one well object based at least in part on a reservoir model associated with the oil and gas production system; and
build the integrated network asset model for the oil and gas production system based at least in part on the network model, the at least one well object, and the fluid properties for the at least one well object.

14. The system of claim 13, wherein the program code is further configured upon execution to:
receive user input that selects the network model from a plurality of existing network models stored in a memory.

15. The system of claim 14, wherein the program code is further configured upon execution to:
generating at least one visualization of the surface production network model to be output to a graphical user interface.

16. The system of claim 15, wherein the at one visualization of the surface production network model is generated prior to retrieving the surface production network model.

17. The system of claim 13, wherein the program code determines the fluid properties for the at least one well object by:
mapping a reservoir associated with the oil and gas production network to the at least one well object.

18. The system of claim 17, wherein mapping the reservoir model to the at least one well object comprises determining a coupling location based at least in part on whether the at least one well object is included in the surface production model.

19. The method of claim 17, wherein mapping the reservoir model to the at least one well object comprises determining fluid transitions between the reservoir model and the at least one well object.

20. A computer program product comprising:
a computer readable storage medium; and
program code stored on the computer readable storage medium and configured upon execution to cause at least one processor to:
retrieve a surface production network model associated with the oil and gas production system;
determine at least one well object associated with the surface production network model;
determine fluid properties for the at least one well object based at least in part on a reservoir model associated with the oil and gas production system; and
build the integrated network asset model for the oil and gas production system based at least in part on the network model, the at least one well object, and the fluid properties for the at least one well object.
